(19) United States
(12) Patent Application Publication
(10) Pub. No.: US 2005/0187008 A1
(43) Pub. Date: Aug. 25, 2005

(54) Gaming machine

(75) Inventor: Yukako Nakajima, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Aruze Corp., Tokyo (JP)

(21) Appl. No.: 11/047,821

(22) Filed: Feb. 2, 2005

(30) Foreign Application Priority Data
Feb. 2, 2004 (JP) 2004-025757

(51) Int. Cl. A63F 13/00

(52) U.S. Cl. 463/20

(57) ABSTRACT

A gaming machine includes symbol display unit 4 for variably displaying a plurality of symbols; game element acquisition unit 2 for selecting a symbol displayed on the symbol display unit 4 and acquiring a game element based on the selected symbol; game processing unit 3 for performing game processing for players to compete with each other for the number of acquired areas based on the game element acquired in the game element acquisition unit 2; and game display unit 5 for displaying the processing result of the game processing unit 3.

### CROSS-REFERENCE TO THE RELATED APPLICATION(S)

The application is based upon and claims a priority from prior Japanese Patent Application No. 2004-025757 filed on Feb. 2, 2004, the entire contents of which are incorporated herein by reference. The application is related to co-pending U.S. application claiming priority on Japanese Patent Application No. 2004-040537. The co-pending application is expressly incorporated herein by reference.

### BACKGROUND OF THE INVENTION

1. Field of the Invention

The present invention relates to a gaming machine and a gaming program.

2. Description of the Related Art

A gaming machine for variably displaying symbol rows each with a plurality of symbols placed thereon, stopping the variation according to operation of the player, and competing with the player based on the displayed symbol combination is known as a slot machine, for example.

For example, in a general slot machine, three reels are placed side by side at the rear of a front panel and various symbols are drawn on the surface of each reel. The symbols can be observed through a window. The reels are provided with a drive mechanism and the player starts to rotate each reel by operating a start lever. As the reels are rotated, the symbols on each row are variably displayed on the window. The player presses a stop button while observing the varying symbols, thereby stopping rotation of each reel. The symbols responsive to the operation timing of the stop button are displayed on each reel. A plurality of pay lines are provided on the window and when a predetermined combination of the symbols is displayed on any pay line, the player wins the game in response to the combination of the symbols. The player competes with the gaming machine for the timing of pressing the stop button so as to display a predetermined combination of the symbols on any pay line.

Generally, the winning state includes a big bonus, a medium bonus, a small bonus, etc., and the player can win any of the prizes according to the symbol combination on the pay line. Before the stop button is pressed, the winning state is already determined by random number lottery (internal lottery) at the start lever operation time, and the player can win the game (prize) by stopping the winning symbol combination determined by the lottery on the pay line.

There is proposed a slot machine for playing a game such as cards using reels. The slot machine includes five reels rather than usual three reels and symbols of cards are arranged on the reels for the player to play poker according to the symbols of the cards stopped on a pay line. The slot machine involves the following problem: Since the number of the symbols that can be distributed to the reels is limited, the display mode of the displayed cards is limited.

In order to solve the above problem, a slot machine is proposed wherein reels are separated into a reel on which integers of 1 to 13 are arranged and a reel on which card suits (spade, heart, club, and diamond) are arranged and the card symbols are represented using numerals and suits in combination, whereby a usual poker state is reproduced on the machine. (For example, refer to JP-A-2002-248201.)

### SUMMARY OF THE INVENTION

The above-described slot machine is intended for providing a poker game on the slot machine and the reels of the slot machine are used only as display unit for displaying the card symbols. Thus, the games that can be applied to the slot machine are limited to those wherein a win or a loss is determined only according to the combination of the symbols displayed on the reels when the reels stop.

Thus, the games are limited to simple games such as poker as the game is over by one reel operation. Since a win or a loss is determined only according to one symbol combination, the slot machine can be applied to a one-person game played by one player, but is not suited for a game played by two or more players.

Therefore, a gaming machine using a symbol combination like a gaming machine using reels of a slot machine in the related art involves a problem of a narrow game application range in the types of games, the number of players entering a game, etc.

It is therefore one of objects of the invention is to widen the application range in the game types, the number of players entering a game, etc., in a gaming machine using a symbol combination. It is another object of the invention to provide a gaming machine with competition and strategy properties for improving interest by more than one operation and game element combination obtained by each operation.

According to a first aspect of the invention, there is provided a gaming machine including: a symbol display unit that variably displays a plurality of symbols arranged on a reel; a game element acquisition unit that selects a symbol displayed on the symbol display unit and acquires a game element based on the selected symbol; a game processing unit that performs game processing for players to compete with each other for a number of acquired areas based on the game element acquired in the game element acquisition unit; and a game display unit that displays the processing result of the game processing unit.

According to a second aspect of the invention, there is provided a computer-readable program product for causing a computer to execute: displaying a varying state and a stop state of a plurality of symbols; varying the symbols and acquiring a game element from the symbol at a stop position; partitioning a predetermined area into a plurality of division areas and determining possession of each of the division areas; determining one of the division areas based on a specific element extracted out from the acquired game element; determining possession of the determined division area by extracting out a possession element from the acquired game element; extracting a division area in the same possession existing in any of longitudinal, lateral, or slanting direction with a division area in different possession between relative to the division area in the determined possession; changing possession of the division area in the different possession sandwiched between the division areas; and determining the division areas possessed by each of a plurality of players and determines a number of the possessed division areas for each of the players.

According to a third aspect of the invention, there is provided an automatic game performing method executed in a computer including the steps of: displaying a varying state and a stop state of a plurality of symbols; varying the symbols and acquiring a game element from the symbol at a stop position; partitioning a predetermined area into a plurality of division areas and determining possession of each of the division areas; determining one of the division areas based on a specific element extracted out from the acquired game element; determining possession of the determined division area by extracting out a possession element from the acquired game element; extracting a division area in the same possession existing in any of longitudinal, lateral, or slanting direction with a division area in different possession between relative to the division area in the determined possession; changing possession of the division area in the different possession sandwiched between the division areas; and determining the division areas possessed by each of a plurality of players and determines a number of the possessed division areas for each of the players.

### BRIEF DESCRIPTION OF THE DRAWINGS

These and other objects and advantages of the present invention will be more fully apparent from the following detailed description taken in conjunction with the accompanying drawings, in which:

FIG. 1 is a schematic block diagram to describe the configuration of a gaming machine of the invention;

FIG. 2 is a drawing to describe an example of a display section of the invention;

FIGS. 3A to 3C are drawings to describe another example of the display section of the invention;

FIGS. 4A to 4H are drawings to show examples of symbol rows of reels of the invention;

FIG. 5 is a flowchart to describe an operation example of the gaming machine of the invention;

FIGS. 6A to 6J show a display example to describe the operation example of the gaming machine of the invention;

FIGS. 7A to 7G show a display example to describe the operation example of the gaming machine of the invention;

FIGS. 8A to 8H show a display example to describe the operation example of the gaming machine of the invention;

FIGS. 9A and 9B are drawings to describe the layouts of the gaming machines of the invention;

FIG. 10 is a block diagram to describe a first mode of the gaming machine of the invention;

FIG. 11 is a flowchart to describe the first mode of the gaming machine of the invention;

FIG. 12 is a block diagram to describe a second mode of the gaming machine of the invention;

FIG. 13 is a flowchart to describe the second mode of the gaming machine of the invention;

FIG. 14 is a block diagram to describe a configuration example of a control circuit for controlling the gaming machine of the invention;

FIG. 15 is a block diagram to describe a third mode of the gaming machine of the invention;

FIG. 16 is a flowchart to describe the third mode of the gaming machine of the invention;

FIGS. 17A and 17B are drawings to describe examples of display sections;

FIGS. 18A to 18J are drawings to describe symbol combination selection operation in the third mode the invention;

FIGS. 19A to 19J are drawings to describe symbol combination selection operation in the third mode the invention;

FIG. 20 is a perspective view showing a gaming machine according to a fourth embodiment;

FIG. 21 is a block diagram showing a electrical circuit provided in the gaming machine; and

FIG. 22 is a flowchart showing an example of operation of the gaming machine.

### DETAILED DESCRIPTION OF THE PREFERRED EMBODIMENTS

Referring now to the accompanying drawings, there are shown preferred embodiments of the invention.

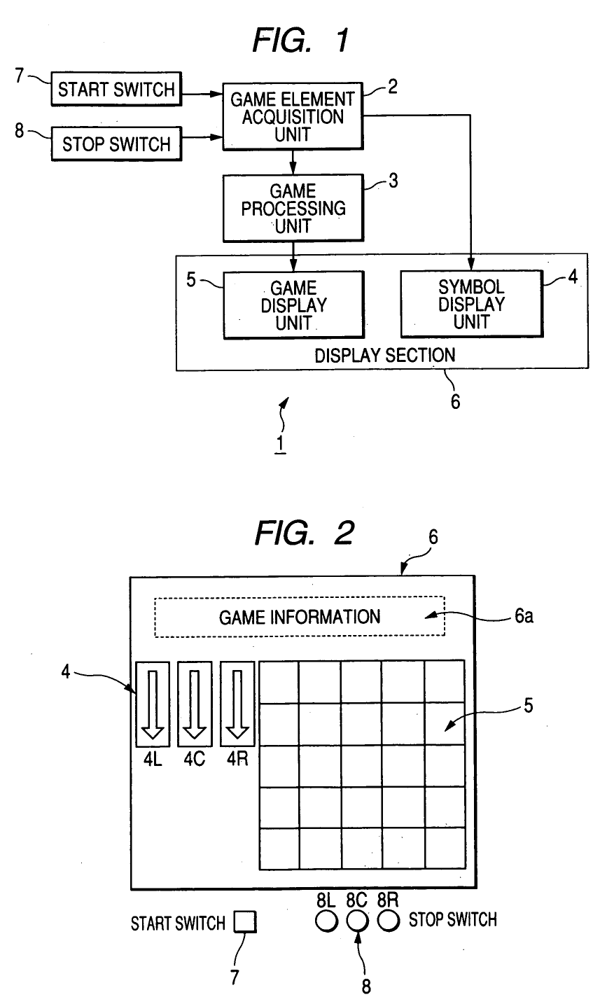

FIG. 1 is a schematic block diagram to describe the configuration of a gaming machine of the invention. A gaming machine 1 includes symbol display unit 4 for variably displaying a plurality of symbols, game element acquisition unit 2 for selecting symbols displayed on the symbol display unit 4 and acquiring game elements based on the selected symbols, game processing unit 3 for performing game processing of competing for the number of obtained areas based on the game elements acquired by the game element acquisition unit 2, and game display unit 5 for displaying the processing result of the game processing unit 3.

The game element acquisition unit 2 includes a selection function of selecting the symbols displayed on the symbol display unit 4 and a game element acquisition function of acquiring the game elements based on the selected symbols. The game element acquisition unit 2 includes a plurality of reels each with a symbol row made up of a plurality of symbols displayed on the surface of the reel, for example, and rotates the reels separately and stops the reels at the timing selected by the player, thereby selecting the symbols. The selected symbols are displayed on the symbol display unit 4.

Each of the reels is provided with a symbol row and the reels are stopped separately, whereby variously combined symbols can be selected. As the symbols, any of digits, characters, patterns, etc., can be set as desired.

The player starts to rotate each reel by operating a start switch 7 such as a start lever, for example. Rotation of the reels can be started all at once or can be started separately by operating the start switch 7. The player stops rotating the reels by operating a stop switch 8. The reels can be stopped separately by operating each of the stop switches provided in a one-to-one correspondence with the reels.

The player starts rotating the reels which initially stop by operating the start switch 7 and after predetermined speed is reached, the player operates the stop switch 8 to stop rotating each of the reels. As the reels are stopped, the selected symbols are displayed on the symbol display unit 4. The symbols preceding and following the selected symbols may be displayed.

At the time, the player operates the stop switches 8 timely so as to display desired symbols while observing the symbol display on the rotating reels. As the player operates the stop switches 8 for the reels, symbol combinations are selected. The selected symbol combinations are displayed on the symbol display unit 4.

The game element acquisition unit 2 acquires game elements based on the selected symbols. The game elements make up a game and are used in advancing the game and are determined in response to the rule of the game. For example, to advance the game by moving a piece on a game board, motion as to what position on the game board and how the piece is to be moved to, the playing order of the players operating the piece, and the like are adopted as the game elements, whereby the game is played.

The game element acquisition unit 2 determines the game elements based on the selected symbol combination. For example, piece motion of the piece destination position, processing of a different piece, etc., and the player moving the piece are determined according to the symbols and the symbol combination. The game processing unit 3 performs game processing based on the game rule using the game elements acquired by the game element acquisition unit 2, and determines a win or a loss of the game.

In the gaming machine using the slot machine in the related art, a win or a loss of the game is determined according to the selected symbol combination; while, the game element acquisition unit 2 of the gaming machine of the invention determines the game elements according to the selected symbol combination and the game processing unit 3 performs game processing using the game elements and determines a win or a loss of the game.

The difference between use of only the selected symbols and use of the game elements determined from the selected symbols appears not only in the game processing mode as described above, but also in the display mode.

The gaming machine 1 of the invention includes symbol display unit 4 and game display unit 5 as a display section 6 and displays the symbols selected by the game element acquisition unit 2 on the symbol display unit 4 and displays the game processing result of the game processing unit 3 using the game elements determined from the selected symbols on the game display unit 5. The player can adjust the timing of pressing the stop switch 8 so as to display selected symbols by observing the symbol display unit 4. The player can also examine the gate state determined by the game elements and work out a game strategy, etc., by observing the game display unit 5.

In contrast, in the gaming machine using the slot machine in the related art, symbol display and game display are in one piece and there is no room to incorporate the game elements as in the invention and the game ability and the competition ability cannot be provided.

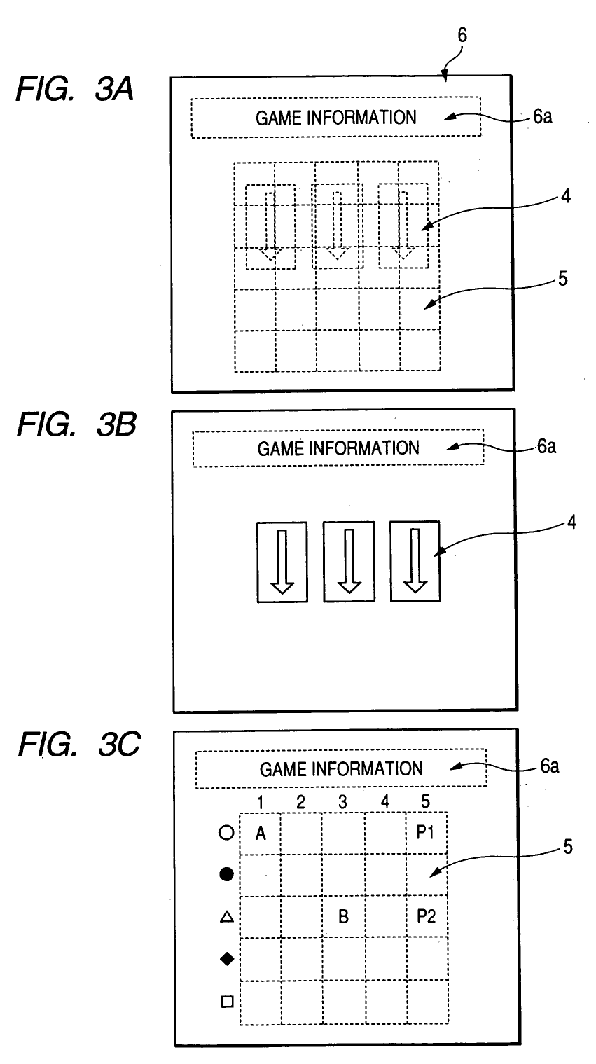

FIGS. 2 and 3 are drawings to describe examples of the display section. FIG. 2 shows a configuration example of the display section wherein the symbol display unit 4 and the game display unit 5 are placed side by side on the same liquid crystal display.

The symbol display unit 4 electrically displays reels 4R, 4C, and 4L representing the reels of a slot machine on the liquid crystal display. The number of the reels is not limited to three and any number of the reels can be set in response to the game elements. Each reel display of the symbol display unit 4 is circulated as a symbol row made up of a plurality of rows is rotated in order; as the start switch 7 is operated, rotation is started and as the stop switch 8 is operated, rotation is stopped.

Here, rotation of all reels is started as the player operates the start switch 7. In the rotation display, operation display of moving the symbol rows is produced. In FIG. 2, the operation display is indicated by arrows. Rotation of all reels may be started not only simultaneously, but also separately. Rotation of the reels 4R, 4C, and 4L is stopped separately as the player operates stop switches 8R, 8C, and 8L, and the symbols selected at the stop time are displayed as still symbols. The stop switches 8 (8R, 8C, and 8L) are provided in a one-to-one correspondence with the reels (4R, 4C, and 4L) of the symbol display unit 4; alternatively the reels may be stopped in order by operating one stop switch.

In the gaming machine 1 according to the embodiment, the reels 4R, 4C, 4L variably displayed by the symbol display unit 4 stop when the stop switch 8 is operated by the player.

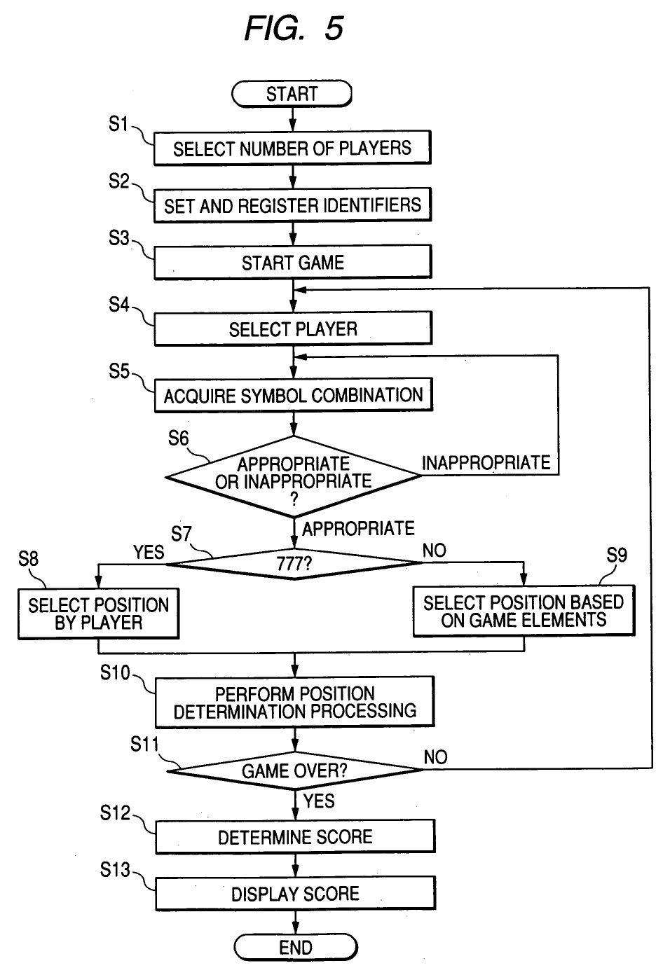

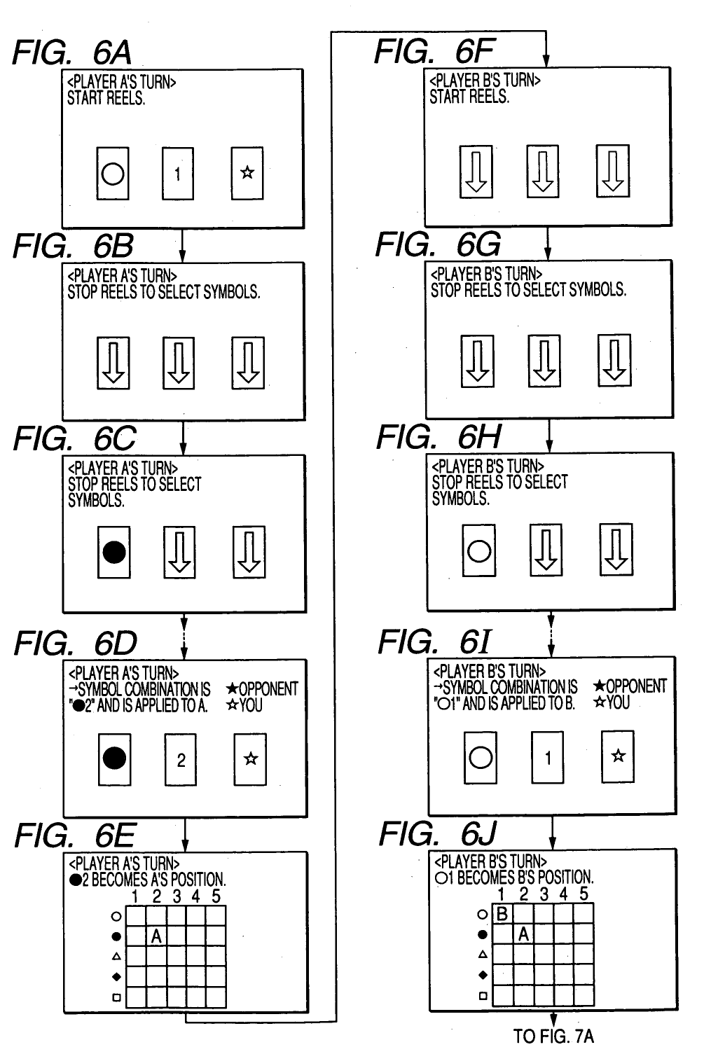

However, it is possible to configure the gaming machine 1 to automatically stop the reels 4R, 4C, 4L that are variably displayed based on a control by the game element acquisition unit 2 or the game processing unit 3 (or by the CPU 11 in the embodiments which will be described later). According to this configuration, there is no need to provide the stop switch 8 and the structural configuration of the gaming machine 1 can be simplified. Moreover, due to the simplification of the game progress by eliminating the stop switch 8, the player can easily acquaint himself to the game. In a case where this configuration is applied, the process to determine that whether or not the selected symbol combination is a symbol combination whose use is improper in the game processing (the process of step S6 shown in FIG. 6) may be included in the process to perform an inner lottery to determine the winning state (the process included in the process of step S5 shown in FIG. 5).

The game display unit 5 is a portion for producing liquid crystal display of the game state. The game display unit 5 shown in FIG. 2 produces liquid crystal display of a grid representing a game area. To take a reversi-type game for players to compete with each other for the number of obtained areas as an example, each cell of the grid portion represents one of the division areas provided by dividing all area. In the example in FIG. 2, a game information section 6a for displaying game information representing the description and the progress state of the game is provided.

The configuration of the game display unit described above enables the player to observe the display content produced by the symbol display unit 4 and that produced by the game display unit 5 on one liquid crystal display.

The display section shown in FIGS. 3A to 3C has the symbol display unit 4 for producing rotation display of mechanical reels and the game display unit 5 for producing liquid crystal display as layers; the mechanical reels of the symbol display unit 4 are provided at the rear of the screen of the liquid crystal display of the game display unit 5 so that the mechanical reels can be rotated and stopped.

The liquid crystal display has a liquid crystal material sandwiched between transparent glass substrates for producing the display content by controlling the voltage applied to the substrate, and can also be placed in a transparent state. As the screen of the liquid crystal display is placed in the transparent state, the mechanical reels provided at the rear of the screen of the liquid crystal display can be observed through the transparent glass substrates.

FIG. 3A shows the symbol display unit 4 and the game display unit 5 superposed on each other. FIG. 3B shows a state in which the screen of the liquid crystal display of the game display unit 5 is placed in the transparent state for displaying the symbol display unit 4 of the mechanical reels provided at the rear of the screen of the liquid crystal display. FIG. 3C shows a display state of producing game display on the screen of the liquid crystal display of the game display unit 5.

According to the state in FIG. 3B, the player can observe rotation display of the mechanical reels and the symbols in the stop state of the mechanical reels through the transparent glass substrates of the game display unit 5.

Symbol display of the mechanical reels and game display of the liquid crystal display can also be produced at the same time by controlling the screen of the liquid crystal display of the game display unit 5.

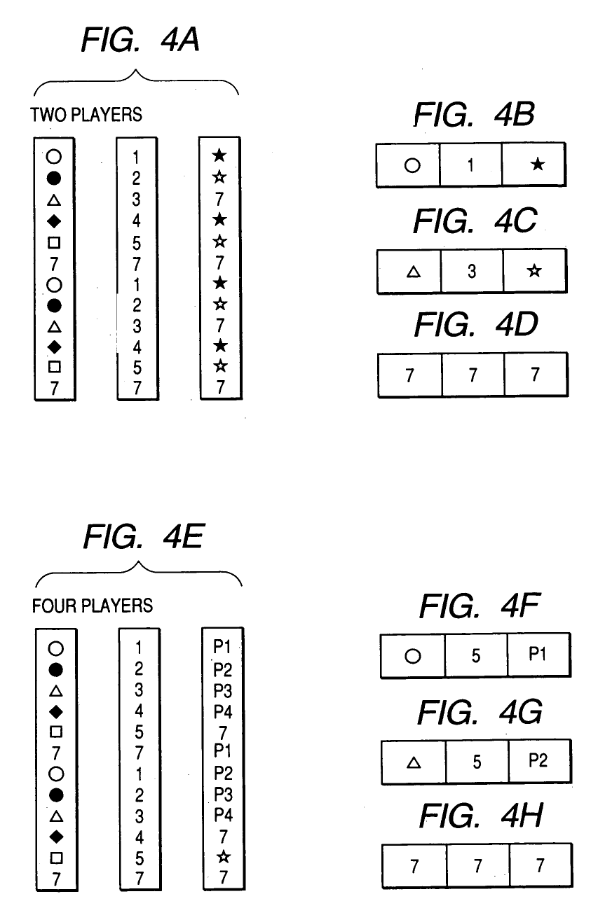

FIGS. 4A to 4H are drawings to show examples of the symbol rows of the reels. FIGS. 4A to 4D show an example of the symbol rows in the case where the number of players is up to two, and FIGS. 4E to 4H show an example of the symbol rows in the case where the number of players is up to four. In both examples, the case where the number of the reels is three is shown, but the number of the reels is not limited to three and any number of the reels can be set in response to the game.

In the embodiment, it is assumed that a plurality of players play the game and compete with each other. The plurality of players may include one or more computer character in which the operation thereof is automatically processed. The operation (game play) by the computer character is achieved as such by the game processing unit 3 being progressing the game in accordance with a software program. According to this configuration, the game may be played by a single player as such by playing against the computer character. Moreover, in a case where more than one players plays the game, the game progress becomes more unpredictable by including one or more computer character, thereby the entertainment of the game can be improved. When the computer character is included as a player, one of the star marks that represent the players may be allocated to the computer character.

One of the three reels shown in FIG. 4A is provided with a symbol row made up of marks such as white circle, black circle, and white triangle, another reel is provided with a symbol row made up of digits of 1 to 7, and still another reel is provided with a symbol row made up of player determining marks (in FIG. 4A, two types of stars (in white and in black) are shown).

The game elements can be determined according to the combination of the symbols. FIGS. 4B to 4D show examples of the game elements based on the combinations of the symbols. For example, in FIG. 4B, the cell of the position on the game board of the game element is determined by the combination of the symbol of the “white circle” mark and the symbol of the digit of “1,” and the symbol of the star (displayed in black) represents the player's possession as the game element (here, player A). This means that in FIG. 3C, the position of the grid cell where “white circle” of the first row and “1” of the first column cross each other is determined and A indicated at the position indicates that the area is in the possession of player A.

In FIG. 4C, the cell of the position on the game board of the game element is determined by the combination of the symbol of the “white trianble” mark and the symbol of the digit of “3,” and the symbol of the star (displayed in white) represents the player's possession as the game element (here, player B). This means that in FIG. 3C, the position of the grid cell where “white triangle” of the third row and “3” of the third column cross each other is determined and B indicated at the position indicates that the area is in the possession of player B.

One of the three reels shown in FIG. 4A is provided with a symbol row made up of marks such as white circle, black circle, and white triangle, another reel is provided with a symbol row made up of digits of 1 to 7, and still another reel is provided with a symbol row made up of player determining marks (in FIG. 4E, four types of marks (P1 to P4) are shown).

The game elements can be determined according to the combination of the symbols. FIGS. 4F to 4H show examples of the game elements based on the combinations of the symbols. For example, in FIG. 4F, the cell of the position on the game board of the game element is determined by the combination of the symbol of the “white circle” mark and the symbol of the digit of “5,” and the symbol of “P1” represents the player's possession as the game element (here, player P1). This means that in FIG. 3C, the position of the grid cell where “white circle” of the first row and “5” of the fifth column cross each other is determined and P1 indicated at the position indicates that the area is in the possession of player P1.

In FIG. 4G, the cell of the position on the game board of the game element is determined by the combination of the symbol of the “white triangle” mark and the symbol of the digit of “5,” and the symbol of “P2” represents the player's possession as the game element (here, player P2). This means that in FIG. 3C, the position of the grid cell where “white triangle” of the third row and “5” of the fifth column cross each other is determined and P2 indicated at the position indicates that the area is in the possession of player P2.

A common symbol to the reels in FIG. 4A, 4E is provided and when all are complete, some game element can also be assigned. For example, a digit of “7” is provided in each reel and when the symbols of the digit of “7” are complete on all reels as in FIG. 4D, 4H, special processing is performed in such a manner that the current game player changes opponent's possession of the area or player's possession of the area defined by a predetermined game rule.

The reels shown in FIGS. 4A to 4H are by way of example, and the number of the reels, the number, the types, the placement order, etc., of the symbols provided on the surface of one reel can be set as desired. Although the diameter and the rotation speed of each reel can also be determined as desired, all reels are set to the same reel diameter, the same number of symbols, and the same rotation speed, whereby they can be set to the same symbol move speed when the player observes the symbols on the reels.

A diameter of the reel, the number of symbols, and the rotation speed are changed for each reel, whereby each reel can be set to different symbol move speed when the player observes the symbols on the reels.

In order to display the symbols with electric reels of liquid crystal, etc., the diameter of the reel, the rotation speed, etc., can be changed by adjusting the change speed of a movably displayed image.

Next, an operation example of the gaming machine of the invention will be discussed with a flowchart of FIG. 5 and display examples shown in FIGS. 6 to 8. In the description that follows, a reversi-type game for players to compete with each other for the number of obtained division areas in a predetermined area made up of a plurality of division areas is taken as an example.

To start a game, the number of players is selected (step S1) and the identifiers of names, nicknames, etc., of the player are set if necessary. Although the identifiers may be set or may not be set in the gaming machine as the players desire, if the identifiers are set, they can be displayed on the game display surface (step S2).

After a game is started (step S3), the player playing the game is selected. To select the player, the play order can be predetermined and the players can play the game in the predetermined play order (step S4).

The selected player operates the start switch to start reel rotation and then operates the stop switches to stop the rotationally displayed reels. Operating the stop switches is controlled so that the stop switches cannot work until the reel rotation speed exceeds predetermined speed, whereby ease of the stop operation at low rotation speed time can be eliminated.

When the player operates the stop switches, the displayed symbols standing still at the operation point in time are determined on the reels, whereby the symbol combination is also determined and the game elements are also determined accordingly. The game element acquisition unit acquires the game elements involved in the symbol combination (step S5).

The symbol combination selection operation at step S5 will be discussed with FIGS. 6 to 8. Here, the case where two players A and B play a game is shown.

When it is the turn of the player A to play the game, the stop reels are displayed on the symbol display unit and a message of “Player A's turn,” “Start reels” is displayed (FIG. 6A). The player A operates the start switch in response to the message, whereby the reels start to rotate. The rotating reels are displayed on the symbol display unit and a message of “Player A's turn,” “Stop reels to select symbols” is displayed (FIG. 6B). Whenever the player operates the stop switch, the reel rotation stops and the symbols are displayed standing still on each reel. FIG. 6C shows a state in which the left reel in the figure stops and a symbol of “black circle” is displayed thereon.

When the player stops all reels, the stopped reels are displayed on the symbol display unit and a message of “Player A's turn,” “Symbol combination is “black circle: 2” and the cell is in the possession of A” is displayed. Here, “black circle” “2” “white star” is displayed on the symbol display unit and “white star” indicates that the selected symbol combination is in the possession of (is applied to) the player (FIG. 6D).

As the symbol combination is selected, the division area (cell) position and possession as the game elements are determined. In FIG. 6E, the determined division area (cell) position and possession are displayed on the game display unit and a message of “Player A's turn,” “black circle: 2 becomes player A's position” is displayed.

Next, the player's turn is changed from player A to player B. In the play turn of the player B, the stop reels are displayed on the symbol display unit and a message of “Player B's turn,” “Start reels” is displayed (FIG. 6F). The player B operates the start switch in response to the message, whereby the reels start to rotate. The rotating reels are displayed on the symbol display unit and a message of “Player B's turn,” “Stop reels to select symbols” is displayed (FIG. 6G). Whenever the player operates the stop switch, the reel rotation stops and the symbols are displayed standing still on each reel. FIG. 6H shows a state in which the left reel in the figure stops and a symbol of “white circle” is displayed thereon.

When the player stops all reels, the stopped reels are displayed on the symbol display unit and a message of “Player B's turn,” “Symbol combination is “white circle: 1” and the cell is in the possession of B” is displayed. Here, “white circle” “1” “white star” is displayed on the symbol display unit (FIG. 6I).

As the symbol combination is selected, the division area (cell) position and possession as the game elements are determined. In FIG. 6J, the determined division area (cell) position and possession are displayed on the game display unit and a message of “Player B's turn,” “white circle: 1 becomes B's position” is displayed.

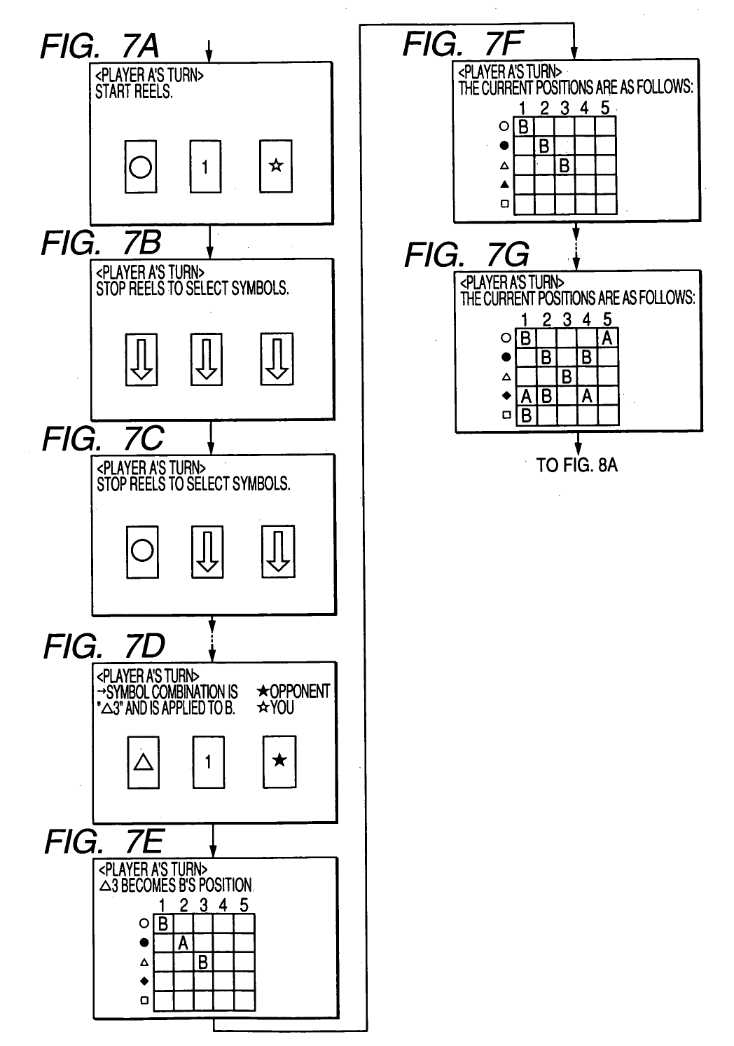

Next, the player's turn is changed again from player B to player A. In the play turn of the player A, the stop reels are displayed on the symbol display unit and a message of “Player A's turn,” “Start reels” is displayed (FIG. 7A). The player A operates the start switch in response to the message, whereby the reels start to rotate. The rotating reels are displayed on the symbol display unit and a message of “Player A's turn,” “Stop reels to select symbols” is displayed (FIG. 7B). Whenever the player operates the stop switch, the reel rotation stops and the symbols are displayed standing still on each reel. FIG. 7C shows a state in which the left reel in the figure stops and a symbol of “white triangle” is displayed thereon.

When the player stops all reels, the stopped reels are displayed on the symbol display unit and a message of “Player A's turn,” “Symbol combination is “white triangle 3” and the cell is in the possession of B” is displayed. Here, “white triangle” “3” “black star” is displayed on the symbol display unit and “black star” indicates that the selected symbol combination is in the possession of (is applied to) the opponent (FIG. 7D).

As the symbol combination is selected, the division area (cell) position and possession as the game elements are determined. In FIG. 7E, the determined division area (cell) position and possession are displayed on the game display unit and a message of “Player A's turn,” “white triangle: 3 becomes B's position” is displayed.

Here, the A's position of the “black circle: 2” cell is sandwiched between the B's positions of the “white circle: 1” cell and the “white triangle: 3” cell in the slanting direction and therefore the position possession is changed. In FIG. 7F, the possession change state is displayed on the game display unit and a message of “Player A's turn,” “The current positions are as follows:” is displayed. The further game progress state is displayed on the game display unit in FIG. 7G.

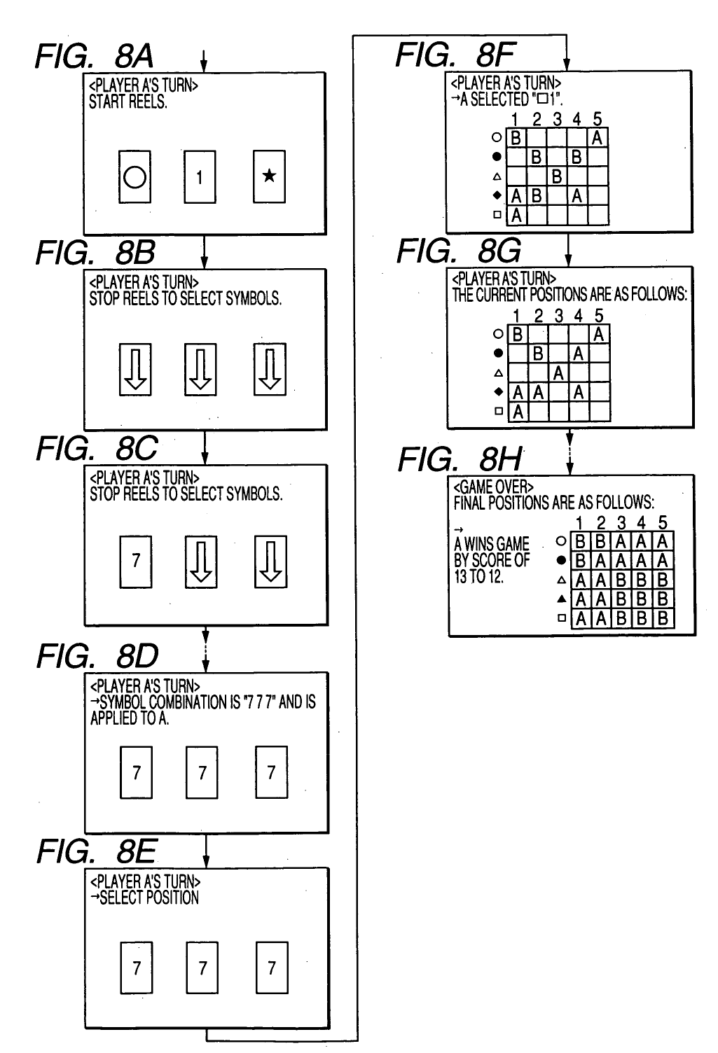

FIGS. 8A to 8H show the game processing state and the game-over state when a specific game element is selected.

Here, the symbol combination of “7,” “7,” “7” is used as the selection combination of a specific game element.

When it is the turn of the player A to play the game, the stop reels are displayed on the symbol display unit and a message of “Player A's turn,” “Start reels” is displayed (FIG. 8A). The player A operates the start switch in response to the message, whereby the reels start to rotate. The rotating reels are displayed on the symbol display unit and a message of “Player A's turn,” “Stop reels to select symbols” is displayed (FIG. 8B). Whenever the player operates the stop switch, the reel rotation stops and the symbols are displayed standing still on each reel. FIG. 8C shows a state in which the left reel in the figure stops and a symbol of “7” is displayed thereon.

When the player stops all reels, the stopped reels are displayed on the symbol display unit and a message of “Player A's turn,” “Symbol combination is 7, 7, 7 and is applied to A” is displayed. Here, “7” “7” “7” is displayed on the symbol display unit and at this time, is applied to the player operating the stop switches (FIG. 8D).

As the symbol combination is selected, a specific game element is selected. As the specific game element, the player can acquire the division area (position) of the opponent. In FIG. 8E, a message of “Player A's turn,” “Select position” is displayed, prompting the player to specify the position to be acquired.

Here, if the player A selects “white square: 1,” the display on the game display unit is changed from “B” to “A” at the selection position (FIG. 8F) and further as the change is made, the slanting B's positions sandwiched between “white square: 1” and “white circle: 5” are changed to the A's positions (FIG. 8G).

The procedure and method for letting the player to select one from the plurality of positions may be arbitrary configured. The gaming machine 1 may be configured to let the player input the selection by use of the start switch 7 and the stop switch 8 with a user interface displayed on the display section 6. The gaming machine 1 may be configured by further providing an input device (such as an input button or a touch panel) for letting the player input the selection.

When the game is over, the final board face is displayed and a message of “Game over,” “Final positions are as follows:” “A wins the game by a score of 13 to 12” is displayed (FIG. 8H).

Whether or not the symbol combination determined as the player operates the stop switches is appropriate is determined. If the symbol combination is inappropriate, a symbol combination is again acquired at step S5. The inappropriate symbol combination applies, for example, if the symbol combination is already acquired or if the use of the symbol combination is improper in the game processing. To determine whether or not the symbol combination is appropriate, the previously acquired symbol combinations are stored and whether or not the selected symbol combination is any of the already acquired symbol combinations is determined and whether or not the selected symbol combination is a symbol combination whose use is improper in the game processing is determined (step S6).

If the selected symbol combination is appropriate, whether or not it is a specific symbol combination (for example, a symbol combination defining a specific game element such as “7 7 7” shown in FIG. 4) is determined (step S7).

If the symbol combination is a specific symbol combination, game processing is performed based on the game element set for the symbol combination. For example, if the specific symbol combination defines a specific game element such as “7 7 7” shown in FIG. 4, game processing is performed conforming to the specific game element. For example, the player selects a division area (position) in the possession of the opponent. In the game processing, the selected division area (position) is changed to the division area (position) in the possession of the player. The game processing is by way of example and can be defined as desired in response to the game rule (step S8).

On the other hand, if the symbol combination is not a specific symbol combination, game processing is performed based on the game elements responsive to the symbol combination, and the division area (position) is selected and is placed in the possession of the player who corresponds to the game elements (step S9).

Whether or not additional variation of division area (position) is possible with respect to the division areas (positions) determined at step S8 or S9 is determined for determining whether or not the game is substantially over (step S10).

If the game is not over (NO at step S11), the process returns to step S4 and steps S5 to S11 are repeated according to the next player.

On the other hand, if the game is over (YES at step S11), the number of the division areas (positions) of the player A and that of the player B are determined for determining which of the players A and B wins the game (step S12), and the game score is displayed on the game display unit (step S13).

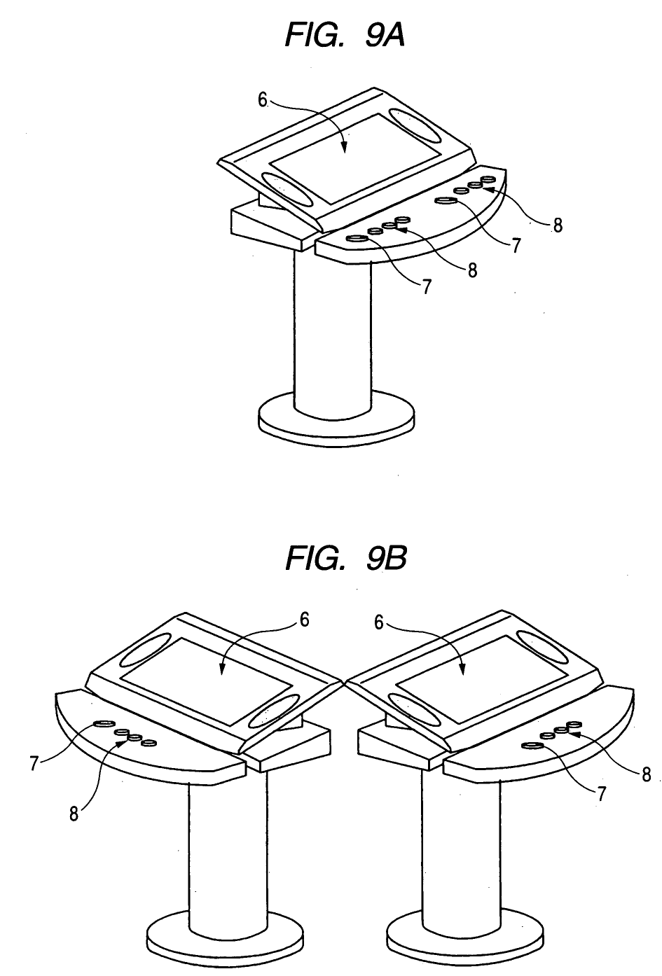

FIGS. 9A and 9B are drawings to describe the layouts of the gaming machines of the invention. FIG. 9A shows an example of the layout of one gaming machine and FIG. 9B shows an example of the layout of two or more gaming machines.

In FIG. 9A, the gaming machine includes two sets each made up of a start switch 7 and a stop section of a set of stop switches 8 for one display section 6, and two players can play a game with one gaming machine.

In FIG. 9B, the gaming machine includes one set made up of a start switch 7 and a stop section of a set of stop switches 8 for one display section 6, and a plurality of (in the figure, two) gaming machines are installed so that a plurality of players can play a game with the two or more gaming machines.

In the configuration (layout) in FIG. 9B, the display section is provided with symbol display unit and game display unit and symbol display and game display are produced on one display screen, but the game display section for producing game display can also be separated from the game display section 6 to provide separate game display unit. According to this configuration, a plurality of players and spectators can watch a game on the separately provided game display unit.

In the layouts (configurations), placement examples of the gaming machines in a gaming house, etc., are shown. However, to play a game in a battle mode, the game can also be played through a network.

Next, more detailed configuration examples of the gaming machine of the invention will be discussed. Processing performed when the selected symbol combination is inappropriate will be discussed in three different modes.

In the first mode, if the selected symbol combination is inappropriate, rotation drive of mechanical reels or circulating display of electric reels is again started and stopped for allowing the player to again select symbols. To do this, re-selection instruction unit is provided.

In the second mode, if the selected symbol combination is inappropriate, the stop position of rotation drive of mechanical reels or circulating display of electric reels is shifted to an appropriate symbol. To do this, next-symbol selection unit is provided.

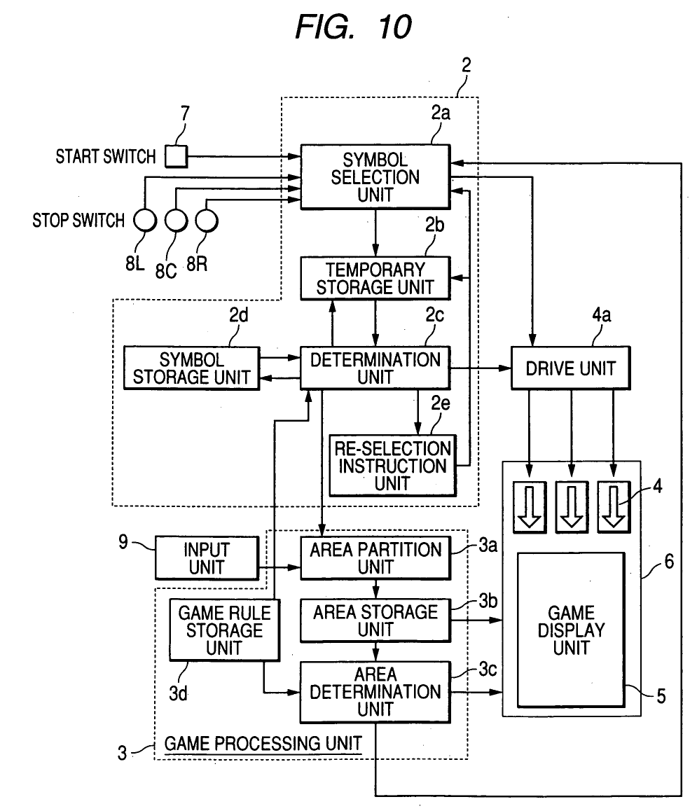

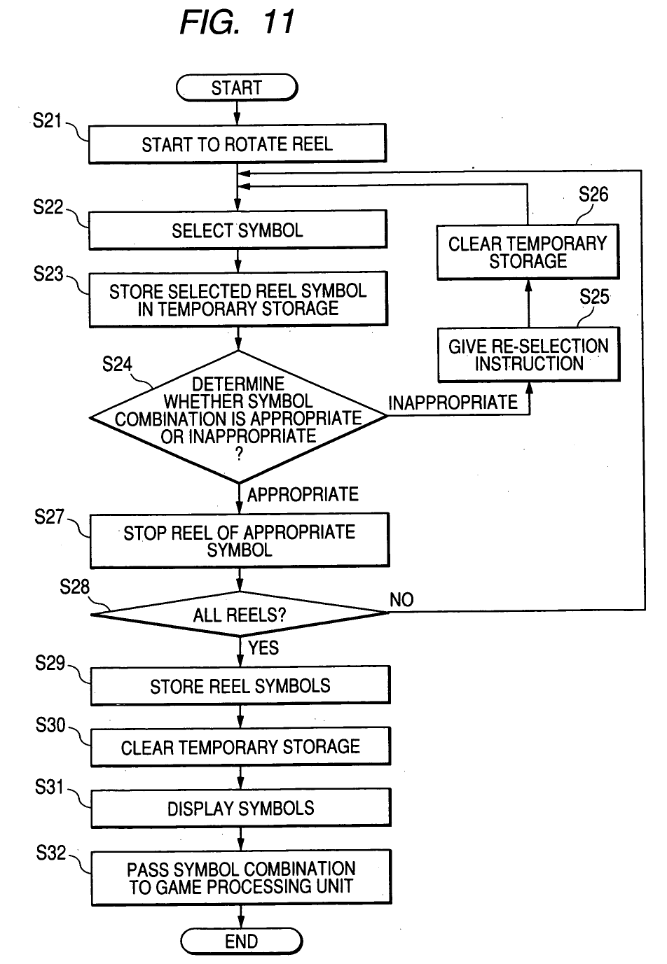

The first mode will be discussed with a block diagram of FIG. 10 and a flowchart of FIG. 11.

In FIG. 10, the schematic configuration of gaming machine 1 is similar to that previously described with reference to FIG. 1. In the configuration in FIG. 10, game element acquisition unit 2 includes a symbol selection unit 2a, a temporary storage unit 2b, a determination unit 2c, a symbol storage unit 2d, and a re-selection instruction unit 2e, and game processing unit 3 includes an area partition unit 3a, an area storage unit 3b, an area determination unit 3c, and a game rule storage unit 3d.

A display unit 6 includes symbol display unit 4 and game display unit 5. The symbol display unit 4 is driven by drive unit 4a and the game display unit 5 produces game display according to the game processing unit 3 and the re-selection instruction unit 2e.

In the game element acquisition unit 2, the symbol selection unit 2a serves for selecting symbols in response to operation of the player; it selects symbols based on signals from start switch 7 and stop switches 8 (8L, 8C, and 8R). The temporary storage unit 2b temporarily stores the symbols on all reels selected through the symbol selection unit 2a for each selection operation.

The determination unit 2c can determine whether or not the symbol combination stored in the temporary storage unit 2b is appropriate by comparing the selected symbol combination with the symbol combinations stored in the symbol storage unit 2d. For example, already selected symbol combinations and symbols whose display is inappropriate on the game progress are stored in the symbol storage unit 2d. A comparison is made between the selected symbol combination stored in the temporary storage unit 2b and each symbol combination read from the symbol storage unit 2d.

If the determination unit 2c determines that the selected symbol combination is an inappropriate symbol combination, the re-selection instruction unit 2e instructs the symbol selection unit 2a to again select the symbol at the point in time at which the symbol was determined inappropriate. For example, when a first symbol is selected, whether or not the symbol combination is appropriate cannot be determined only with the first selected symbol and thus while the reels of the symbol display unit are stopped and symbol display is produced for selecting symbols in order, when the symbol is determined inappropriate, for the symbol determined inappropriate, symbol selection needs to be executed again at the selection timing without stopping the reels of the symbol display unit.

If the determination unit 2c determines that the selected symbol combination is an appropriate symbol combination, the game processing unit 3 is informed of the symbol combination and the symbol combination is also stored in the symbol storage unit 2d.

The determination unit 2c also informs the drive unit 4a of the symbol combination for displaying the symbol combination on the symbol display unit 4. In the configuration, as the player operates the start switch, driving the drive unit 4a is started for starting to rotate the reels of the symbol display unit 4.

In the game processing unit 3, the area partition unit 3a determines the piece placing position and the player based on the symbol combination received from the determination unit 2c and partitions the area forming the game for storage in the area storage unit 3b. The game display unit 5 displays the area state stored in the area storage unit 3b.

The area determination unit 3c determines whether or not the area state is to be changed in accordance with the area state stored in the area storage unit 3b and the game rule stored in the game rule storage unit 3d. To change the area state, the display state of the game display unit 5 is changed.

Whether or not the game is over is determined and if the game is not over, a signal is sent to the symbol selection unit 2a, enabling the next selection operation. If a signal is input from the start switch and the stop switch, the symbol selection unit 2a does not perform selection operation until an enable signal is received from the area determination unit 3c to prevent the next selection operation from being performed before the area change state is confirmed. Area specification and operation specification can also be made through input unit 9.

FIG. 11 is a flowchart to describe an operation example of the game element acquisition unit.

The symbol selection unit 2a starts to rotate the reel based on a start signal from the start switch 7 (step S21) and upon reception of a stop signal from the stop switch 8, starts symbol selection (step S22). The selected symbol is temporarily stored (step S23).

The determination unit 2c determines whether or not the symbol combination stored in the temporary storage unit 2b is appropriate (step S24). If the symbol combination is inappropriate, the determination unit 2c gives a re-selection instruction to the symbol selection unit 2a (step S25) and clears the storage of the temporary storage unit 2b for the symbol at the point in time at which the symbol was determined inappropriate (step S26). If the determination unit 2c determines that the symbol combination is appropriate, the reel of the symbol at the point in time at which the symbol was determined appropriate (step S27). Steps S22 to S27 are executed for all reels (step S28), the symbol combination is stored in the symbol storage unit 2d (step S29), and the temporary storage unit 2b is cleared (step S30).

The selected symbols are displayed on the symbol display unit 4 (step S31) and the selected symbol combination is passed to the game processing unit 3 (step S32).

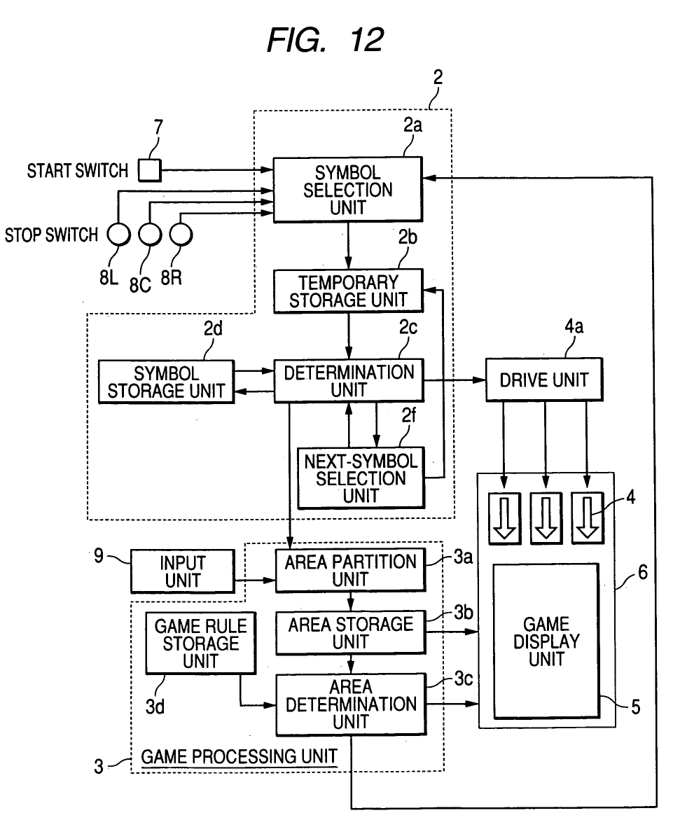

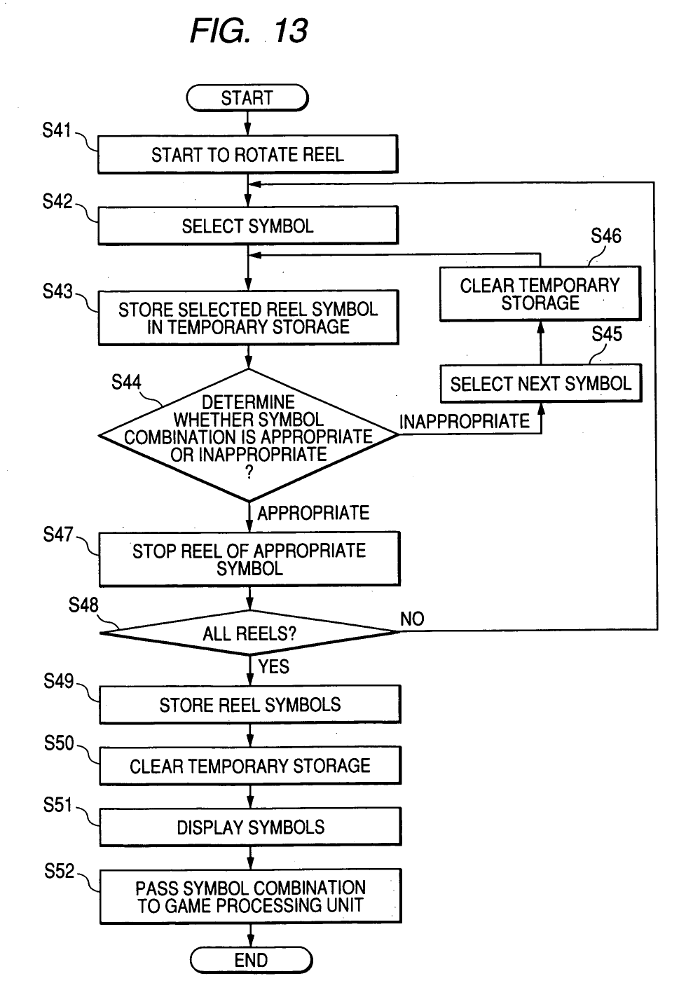

The second mode will be discussed with a block diagram of FIG. 12 and a flowchart of FIG. 13.

The second mode differs from the first mode in processing performed when determination unit determines that the selected symbol is inappropriate, and other components are common to the second and first modes. Therefore, only the difference will be discussed and the common components will not be discussed again.

In the second mode, if the determination unit determines that the selected symbol is inappropriate, shift processing wherein next-symbol selection unit selects the symbol placed following the symbol determined inappropriate in order in the symbol row is performed; the processing is repeated until a symbol determined appropriate is obtained.

To do this, game element acquisition unit 2 includes next-symbol selection unit 2f in place of the re-selection instruction unit 2e in the first mode. Upon reception of the result of determining that the selected symbol is inappropriate from determination unit 2c (step S44), the next-symbol selection unit 2f selects the next symbol arranged in the symbol row on the reel (step S45), erases the preceding symbol determined inappropriate from temporary storage unit 2b (step S46), and stores the newly selected symbol in the temporary storage unit 2b (step S47). This processing is repeated until an appropriate symbol combination is obtained.

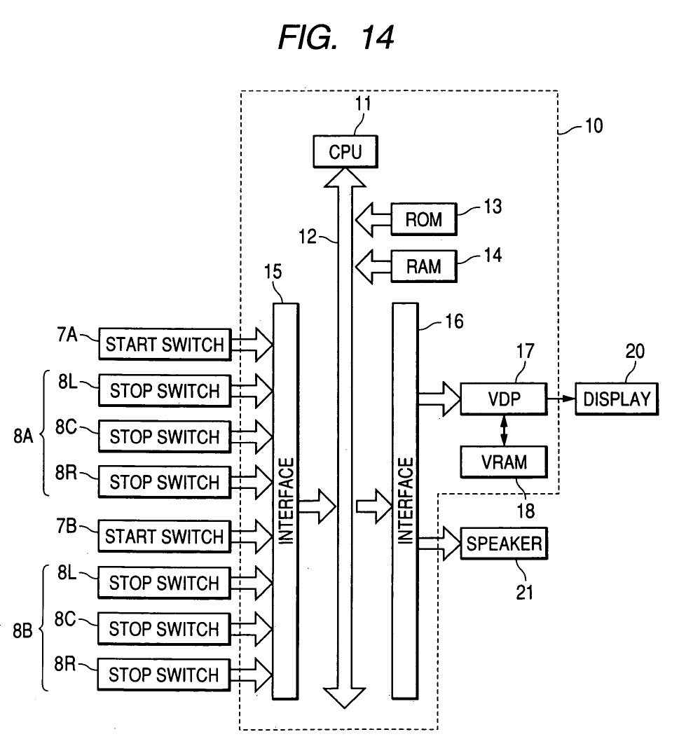

FIG. 14 is a block diagram to describe a configuration example of a control circuit 10 for controlling the gaming machine.

Start switches 7a and 7b and stop switches 8a and 8b (8L, 8C, and 8R) are connected to an input/output bus 12 through an interface 15. When the player operates the start switch 7a, 7b and the stop switch 8a, 8b, the switch operation is converted into a predetermined signal through the interface 15 and the signal is sent to the input/output bus 12. A CPU 11 is connected to the input/output bus 12 via which a data signal and an address signal is input to the CPU 11.

Storages of ROM 13, RAM 14, etc., are connected to the input/output bus 12. The ROM 13 stores a control program for controlling a game of the gaming machine and also stores initial data for executing the control program, a display control program for controlling a display 20, and the like. The RAM 14 store the values of flags and variables used in the program. The variables include information of the symbols and the positions displayed on a screen, and the CPU 11 makes various determinations based on the information. The program, etc., may be stored not only in semiconductor record media of ROM, RAM, etc., but also in other record media of a magneto-optical disk, etc.

An interface 16 is connected to the input/output bus 12. Peripheral devices such as the display 20 and a speaker 21 are connected to the interface 16, and a drive signal and drive power for controlling the peripheral machines are supplied in response to the operation result of the CPU 11.

A video display processor (VDP) 17 and video RAM (VRAM) are connected between the display 20 and the interface 16. The VDP 17 generates a drive signal for driving the display 20 based on image data provided in the VRAM 18 by an image display instruction output from the CPU 11. Accordingly, symbol and game images are displayed on the display 20 of an LCD display, a CRT display, etc. The VDP 17, the VRAM 18, and the display 20 make up display unit.

Next, a third mode of the invention will be discussed. In the mode of gaming machine, a plurality of players operate stop switches at the same time in a battle game to select symbols and if the players select the same symbol combination, the player assigned priority acquires the symbol combination.

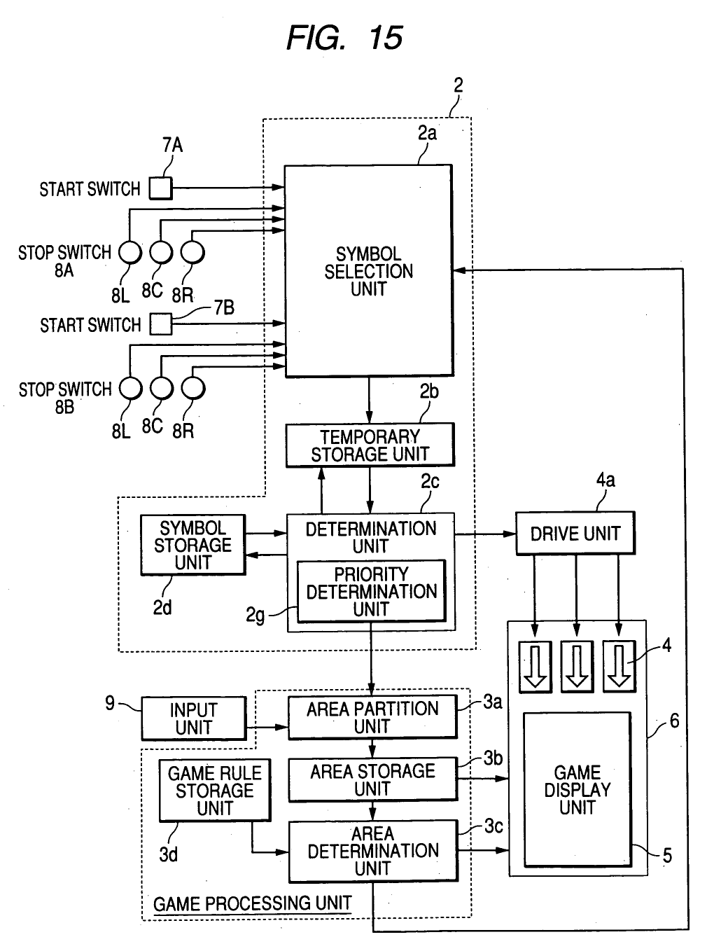

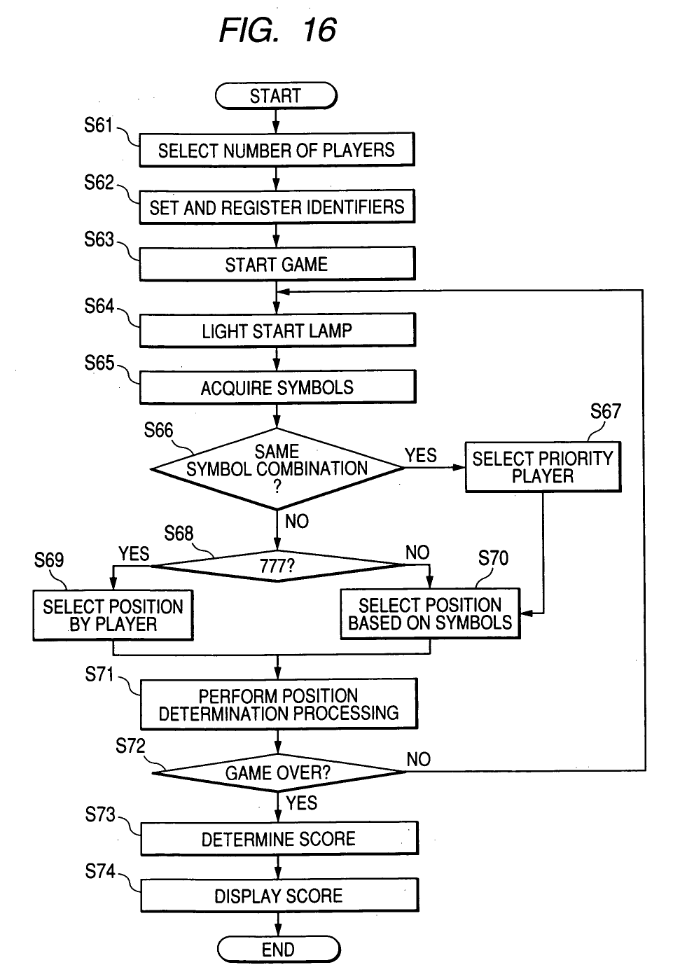

The third mode of the invention will be discussed with a block diagram of FIG. 15 and a flowchart of FIG. 16.

The third mode differs from the first mode, the second mode in processing of symbol selection unit and determination unit and other components are common to the first, second and third modes. Therefore, only the difference will be discussed and the common components will not be discussed again.

In the third mode, symbol selection unit 2a includes symbol selection functions of players. Each symbol selection function starts reel rotation according to start switch operation of the player or start switch function, and stops the reels based on an operation signal of the stop switch 8a, 8b of the player to select symbols. Accordingly, each player operates the stop switches so as to output any desired symbol combination based on the determination of the player for selecting a symbol combination. Game processing is performed based on the game elements responsive to the symbol combination selected by each player.

In the symbol combination selection, the players may select the same symbol combination. If the players select the same symbol combination, determination unit 2c selects one of the players by priority determination unit 2g for performing game processing.

In the flowchart of FIG. 16, to start a game, the number of players is selected (step S61) and the identifiers of names, nicknames, etc., of the player are set if necessary. Although the identifiers may be set or may not be set in the gaming machine as the players desire, if the identifiers are set, they can be displayed on the game display surface (step S62).

After a game is started (step S63), the symbol selection unit 2a starts rotation of the reels of the players at the same time, and informs the players that symbol selection is started by lightening a start lamp, etc., (step S64).

Each player starts reel rotation by operating the start switch of the player or the internal start function. After the reels reach predetermined rotation speed, each player operates the stop switches of the player for stopping the reels so as to obtain any desired symbols. Operating the stop switches is controlled so that the stop switches cannot work until the reel rotation speed exceeds predetermined speed, whereby ease of the stop operation at low rotation speed time can be eliminated.

When the player operates the stop switches, the displayed symbols standing still at the operation point in time are determined on the reels, whereby the symbol combination is also determined and the game elements are also determined accordingly. Game element acquisition unit acquires the game elements involved in the symbol combination (step S65).

Whether or not the symbol combinations selected by the players are the same is determined. If the players select the same symbol combination (YES at step S66), one priority player is selected at step S67. For example, the first player completing symbol selection can be selected as the priority player. At this time, when the players operate the stop switches to obtain the same symbol combination, the first player completing the operation can acquire the symbol combination. However, the player needs to fast operate the stop switches and accordingly the possibility that the player may erroneously operate the switches is increased. On the other hand, to acquire any desired symbol combination, the player needs to operate the stop switches with care. However, accordingly symbol selection slows down and the possibility that the player may be preceded by another player is increased. In the third mode, the competition element is thus introduced between the players to acquire any desired symbol combination, whereby the game can be provided with competition and strategy properties.

After which of the players the selected symbol combination is in the possession of is determined, whether or not the symbol combination is a specific symbol combination (for example, symbol combination defining a specific game element such as “7 7 7” shown in FIG. 4) is determined (step S68).

In the game processing, steps S69 to S74 following step S68 are similar to steps S7 to S13 previously described with reference to the flowchart of FIG. 5 and therefore will not be discussed again.

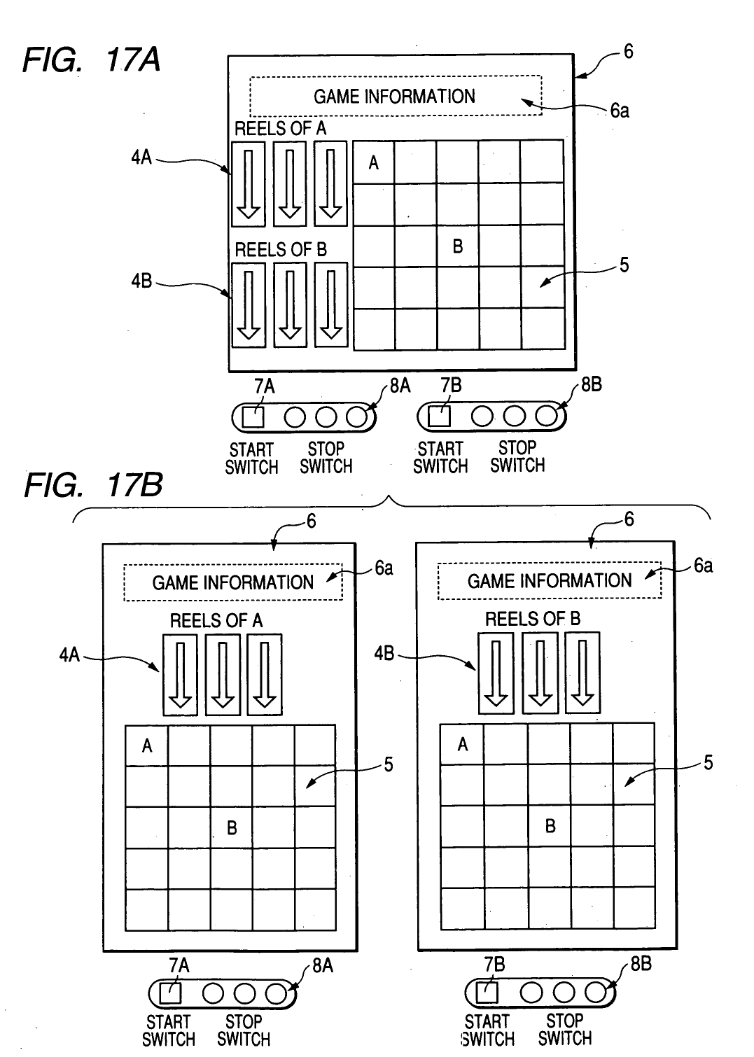

FIGS. 17A and 17B are drawings to describe examples of display sections. FIG. 17A shows a configuration example wherein symbol display unit 4A and 4B and game display unit 5 for two players are provided on the same screen, and FIG. 17B shows a configuration example wherein symbol display unit 4 and game display unit 5 are provided for each player.

In FIG. 17A, a display section 6 includes symbol display unit 4A and 4B and game display unit 5, and with the symbol display unit 4A and 4B, reel stop operation is performed as stop switches 8A and 8B provided for the players are operated.

In FIG. 17B, a display section 6 and a stop switch 8 are provided for each player and each display section 6 includes symbol display unit 4 (4A or 4B) and game display unit 5. With each symbol display unit 4A, 4B, reel stop operation is performed as a stop switch 8A, 8B provided for each player is operated.

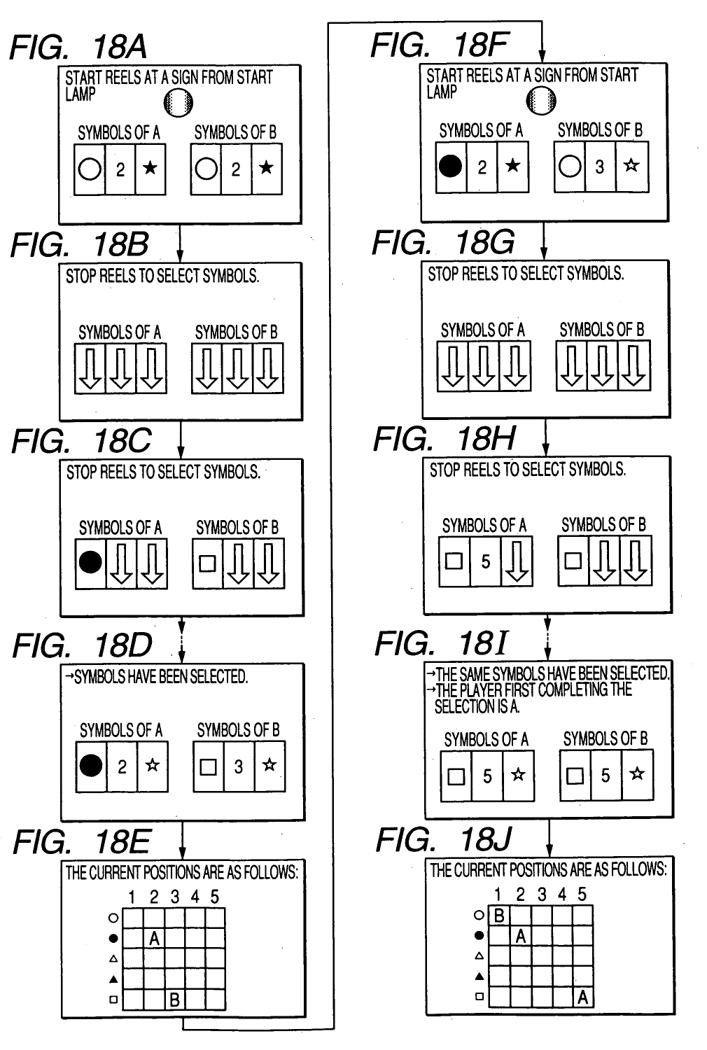

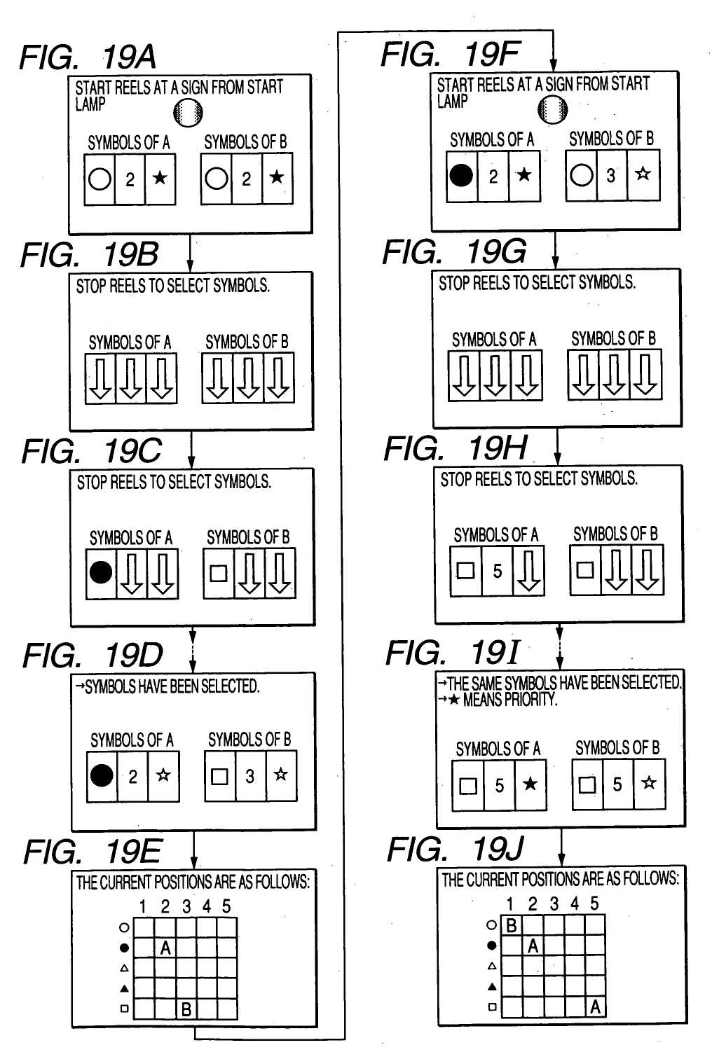

Symbol combination selection operation in the third mode will be discussed with FIGS. 18 and 19. Here, two players of players A and B play a game.

In the example shown in FIGS. 18A to 18J, the first player completing selection is assigned priority and game processing is performed using the symbol combination of the player. Here, “white star” and “black star” in symbols are not used as a game element.

After a game is started, stop reels are displayed on the symbol display unit and a message of “Start reels at a sign from start lamp” is displayed (FIG. 18A). Each player operates the start switch in response to the message, whereby the reels start to rotate. The rotating reels are displayed on the symbol display unit and a message of “Stop reels to select symbols” is displayed (FIG. 18B). Whenever each player operates the stop switch of the player, the corresponding reel stops rotating and symbols standing still are displayed on each reel. FIG. 18C shows a state in which the left reels in the figure stop and a symbol of “black circle” and a symbol of “white square” are displayed.

When all reels are stopped, stop reels are displayed on the symbol display unit and a message of “Symbols have been selected” is displayed. Here, “black circle,” “2,” “white star” and “white square,” “3,” “white star” are displayed on the symbol display unit. “White star” indicates that the selected symbol combination is in the possession of (is applied to) the player (FIG. 18D).

As the symbol combination is selected, the division area (cell) position and possession as the game elements are determined. In FIG. 18E, the determined division area (cell) position and possession are displayed on the game display unit and a message of “The current positions are as follows:” is displayed.

Next, similar operation is performed. Stop reels are displayed on the symbol display unit and a message of “Start reels at a sign from start lamp” is displayed (FIG. 18F). Each player operates the start switch in response to the message, whereby the reels start to rotate. The rotating reels are displayed on the symbol display unit and a message of “Stop reels to select symbols” is displayed (FIG. 18G). Whenever each player operates the stop switch of the player, the corresponding reel stops rotating and symbols standing still are displayed on each reel. FIG. 18H shows a state in which the left reels in the figure stop and symbols of “white square,” “5” and a symbol of “white square” are displayed. At this stage, the player A completes selection of two symbols, but the player B completes selection of only one symbol.

When all reels are stopped, stop reels are displayed on the symbol display unit. At this time, if both the players select the same symbol combination, a message of “The same symbols have been selected” is displayed. Further, a message of “The player first completing the selection is A” is displayed, indicating the player first completing the selection (FIG. 18I).

As the symbol combination is selected, the division area (cell) position and possession as the game elements are determined. In FIG. 18J, the determined division area (cell) position and possession are displayed on the game display unit and a message of “The current positions are as follows:” is displayed.

Next, in the example shown in FIGS. 19A to 19J, a symbol is provided with a game element for assigning priority and game processing is performed using the symbol combination of the player selecting the symbol. Here, “black star” in the symbols is used as the priority game element.

FIGS. 19A to 19J are the same as FIGS. 18A to 18J except FIG. 19I and therefore only the difference between FIGS. 18I and 19I will be discussed.

When stop reels are displayed on the symbol display unit, if both players select the same symbol combination of “white square” and “5, ” a message of “The same symbols have been selected” is displayed.

Here, since the symbol “black star” is the game element representing symbol selection priority, the symbol “black star” is displayed on one reel and the symbol combination is in the possession of (applied to) the player A selecting the symbol “black star” and a message of “black star counts,” “Symbols of A have been selected” is displayed, indicating the player selecting the symbol “black star” (FIG. 19I).

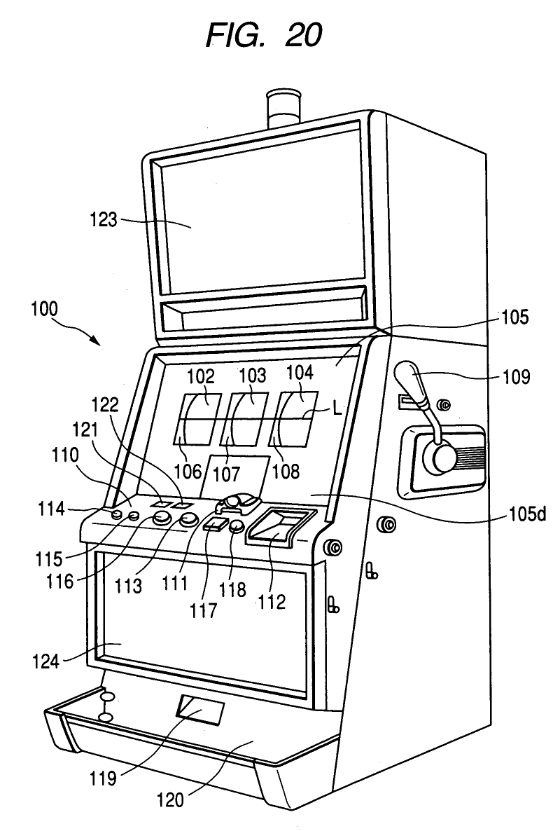

Hereinafter, a fourth embodiment according to the invention will be described in detail. The fourth embodiment will be described with reference to a gaming machine (slot machine) 100 shown in FIG. 20, wherein the game described in the aforementioned embodiments is provided as a bonus game that starts when the symbols are stopped in a specific arrangement that is defined to award a win for the bonus game. One example of such specific arrangement is when a specific combination of symbols is aligned on a pay line.

FIG. 20 shows a slot machine as an example of the gaming machine 100. As shown in the figure, three reels of a first reel 102, a second reel 103, and a third reel 104 are provided for rotation in a cabinet in the center of the main body of the slot machine 100 as a gaming machine. Symbol columns including different types of symbols are drawn on the outer peripheral surface of each of the reels 102 to 104. The symbols are variably displayed as a player operates a handle 109 provided on a side of the cabinet in a usual gaming state in which the player inputs a game medal as a game medium and plays a game. A reel display window section 105 is placed on the fronts of the reels 102 to 104. Three symbols drawn on the outer peripheral surface of each of the reels 102 to 104 are displayed through a display window 106, 107, 108 formed in the reel display window section 105. The reel display window section 105 is formed with a pay line L defining a symbol combination, and a combination is determined by the still symbol combination displayed on the pay line L in the display windows 106 to 108. The reel display window section 105 is made of a transparent liquid crystal panel 105d for displaying various pieces of game information and various game effect images while the player plays a game.

A control panel 110 placed below the reel display window section 105 is provided with a medal insertion slot 11 for a player to input a medal and a bill insertion slot 112 for a player to insert a bill. The control panel 110 is also provided with a spin switch 113 for starting rotation of the reels 102 to 104 by pushbutton operation aside from operation of the handle 109 and is further provided with a change switch 114, a cash out switch 115, a bet 1 switch 116, a max bet switch 117, and a stop button 118.

The change switch 114 switches between paying out the medal gained by the player to a medal tray 120 through a payout opening 119 and reserving the medal in the machine as credit. The number of medals in credit in the machine is displayed on a number-of-reserved-medals display section 121 including seven-segment LEDs (light emitting diodes). As the player pushes the cash out switch 115, the medals in credit are paid out to the medal tray 120. As the player presses the bet 1 switch 116 once, only one of the medals in credit is bet on a game. As the player presses the max bet switch 117 once, as many medals as the maximum number that can be bet on one game are bet on the game. The stop button 118 forms stop command acceptance means for accepting from the player a stop command of the symbol row variably displayed on the liquid crystal panel 105d in a free game. The number of medals paid out from the payout opening 119 when a predetermined combination becomes complete on the pay line L is displayed on a number-of-pay-out-medals display section 122.

A pay table indicating how many medals are paid out for a winning game is displayed on top glass 123 above the reel display window section 105. An image of a character of the gaming machine or the like is drawn on bottom glass 124 below the reel display window section 105.

Next, control means for controlling the progress of a game in the slot machine 100 will be discussed.

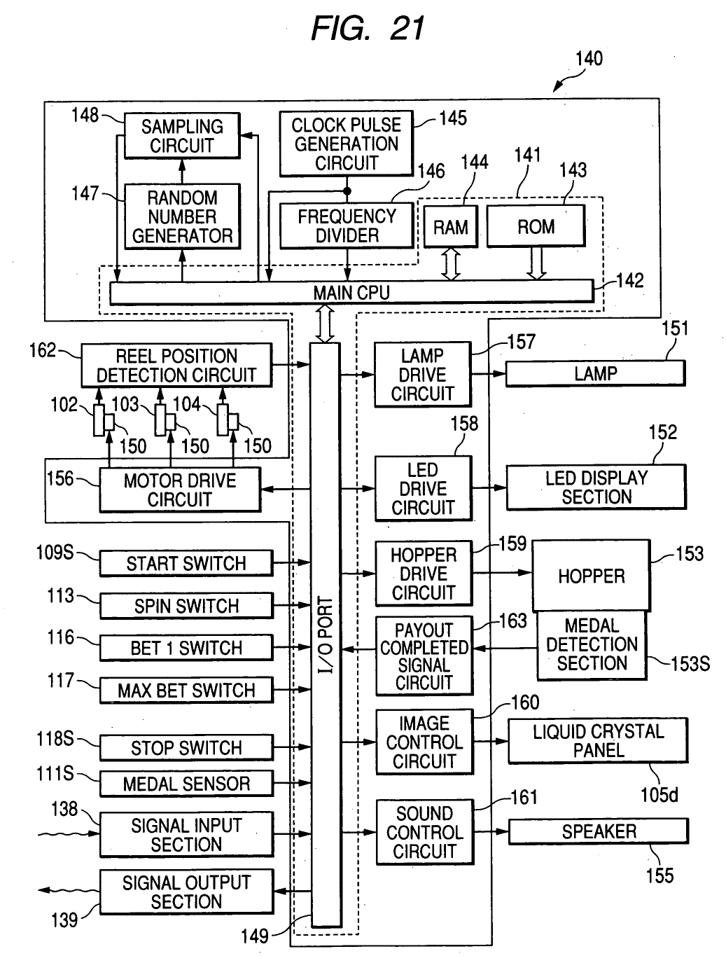

FIG. 21 is a block diagram to show the circuit configuration of a control circuit 140 for controlling the game processing operation of the slot machine 100. As shown in the figure, the control circuit 140 has a microcomputer 141 as a main component, and the microcomputer 141 is including a main CPU (central processing unit) 142 for performing control operation in accordance with a preset program and ROM (read-only memory) 143 and RAM (random access memory) 44 as storage unit. The ROM 143 stores the whole control processing procedure of the gaming machine as a sequence program, and the RAM 144 is used as a temporary storage work area when the program is executed.

Connected to the main CPU 142 are a clock pulse generation circuit 145 and a frequency divider 146 for generating a reference clock pulse, a random number generator 147 for generating a constant range of random numbers, and a sampling circuit 148 for determining one of the generated random numbers. Further, an I/O port 149 for transferring a signal to and from peripheral devices (actuators) described later is connected to the main CPU 142. In the ROM 143, the storage section is divided so as to store a combination table, a variation mode table, etc., in addition to the sequence program.

The microcomputer 141, the random number generator 147, and the sampling circuit 148 serve as a lottery unit for determining a combination by lottery; the still symbols to be displayed on the display windows 106 to 108 or the liquid crystal panel 105d are selected by lottery and a combination is determined by the selected symbol combination.

The main actuators whose operation is controlled by a control signal from the microcomputer 141 include stepping motors 150 for rotating the reels 102 to 104, various lamps 151, an LED display section 152 of the number-of-reserved-medals display section 121, the number-of-pay-out-medals display section 122, etc., a hopper 153 for storing medals, the liquid crystal panel 105d, and a speaker 155, which are driven or controlled by a motor drive circuit 156, a lamp drive circuit 157, an LED drive circuit 158, a hopper drive circuit 159, an image control circuit 160, and a sound control circuit 161 respectively. The drive circuits 156 to 159 and the control circuits 60 and 61 are connected to an output section of the main CPU 142 via the I/O port 149. The microcomputer 141 and the image control circuit 160 serve as stop control unit for defining the variation mode until the symbols selected by the lottery unit become complete on the pay line L in response to the spacing between the position of each symbol on the pay line L at the acceptance timing of the stop command operation with the stop button 18 and the position of each symbol in accordance with the combination determined by the lottery unit on the display of the liquid crystal panel 105d in a free game. Even if the player operates the stop button 118 at any timing, finally the symbol combination determined by the lottery unit always becomes complete on the pay line L regardless of the operation timing. In the embodiment, a signal output section 139 that serves as a communication device for transmitting a signal to other apparatus such as a server and other gaming machines is also connected to the output section of the main CPU 142 via the I/O port 149.

Main input signal generation unit for generating input signals required for the microcomputer 141 to generate control signals include: a signal input section 138 forming communication line for receiving a command signal from other apparatus connected thereto such as a server and other gaming machines; a start switch 109S for detecting operation of the handle 109; the spin switch 113; the bet 1 switch 116; the max bet switch 117; a stop switch 118S for detecting operation of the stop button 118; and a medal sensor 111S for detecting a medal input into the medal insertion slot 111. Further, a reel position detection circuit 162 for detecting the rotation positions of the reels 102 to 104 is included.

Further, the input signal generation unit includes a medal detection section 153S for counting the number of medals paid out from the hopper 153 and a payout completion signal generation circuit 163. The payout completion signal generation circuit 163 generates a signal for detecting completion of the medal payout when the actually paid-out medal count input from the medal detection section 153S reaches the number-of-award-medals data displayed on the number-of-pay-out-medals display section 122. The circuits making up the input signal generation unit are also connected to the main CPU 142 via the I/O port 149.

In the fourth embodiment, the reels 102-104 that are variably displayed are stopped when the player operates the stop switch 118S. However, the gaming machine 100 may be configured that the variable display of the reels 102-104 stop automatically based on the control process processed by the main CPU 142 regardless of the player's operation input via the stop switch 118S.

In the gaming machine 100 according to the fourth embodiment, the reels 102-104 are mechanically rotated to be variably displayed. However, the gaming machine 100 may be configured without providing the reels 102-104 that are mechanically provided and displaying video reels, instead of the reels 102-104, on the liquid crystal panel 105d as such similar to the embodiments described above with reference to FIG. 3.

In the fourth embodiment, the control circuit 140 serves as the game element acquisition unit 2 and the game processing unit 3 of the aforementioned embodiments.

In the gaming machine 100, the symbols arranged on the reels 102-104 are variably displayed as a player operates a handle 109 provided on a side of the cabinet in a usual gaming state in which the player inserts the game medal as game medium and plays the game.

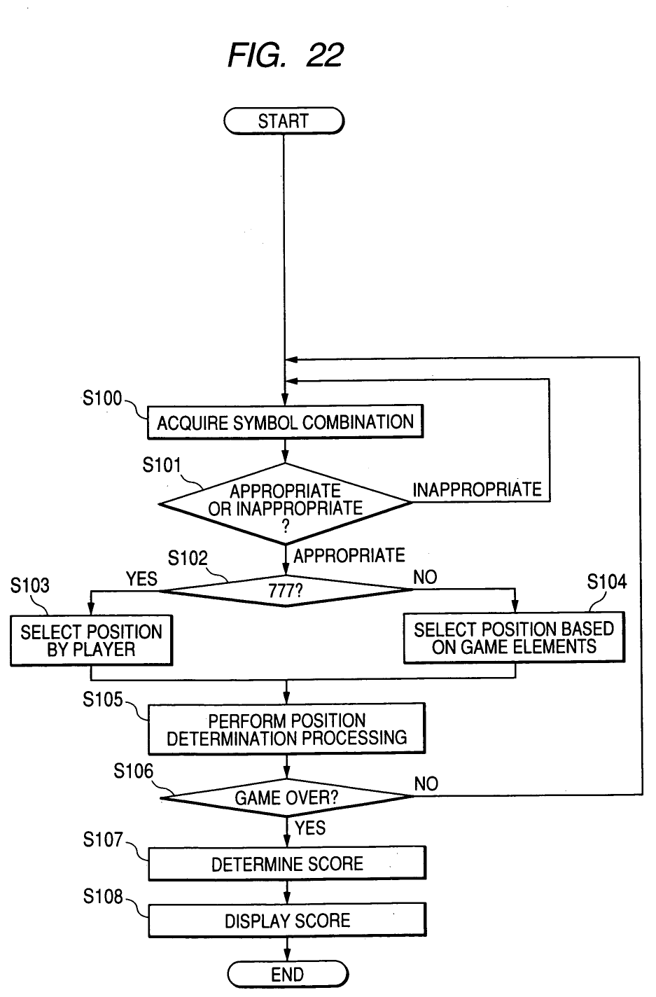

When the symbols are stopped on the pay line L in a specific combination, a so-called bonus game starts. In the bonus game, a procedure similar to the procedure described in the aforementioned embodiments is processed by the main CPU 142, based on a procedure shown in FIG. 22, thereby to perform the bonus game similar to the game described in the aforementioned embodiments.

In the fourth embodiment, it is assumed that the bonus game is played by a single player against a computer character. In the following description of the procedure shown in FIG. 22, detailed description of the processes the same as those shown in FIG. 5 will be omitted.

As shown in FIG. 22, when the bonus game is started, the player operates the start switch to start reel rotation and then operates the stop switches to stop the rotationally displayed reels. Operating the stop switches is controlled so that the stop switches cannot work until the reel rotation speed exceeds predetermined speed, whereby ease of the stop operation at low rotation speed time can be eliminated.

When the player operates the stop switches, the displayed symbols standing still at the operation point in time are determined on the reels, whereby the symbol combination is also determined and the game elements are also determined accordingly. The game element acquisition unit acquires the game elements (symbols) involved in the symbol combination (step S100).

Whether or not the symbol combination determined as the player operates the stop switches is appropriate is determined. If the symbol combination is inappropriate, a symbol combination is again acquired at step S100. The inappropriate symbol combination applies, for example, if the symbol combination is already acquired or if the use of the symbol combination is improper in the game processing. To determine whether or not the symbol combination is appropriate, the previously acquired symbol combinations are stored and whether or not the selected symbol combination is any of the already acquired symbol combinations is determined and whether or not the selected symbol combination is a symbol combination whose use is improper in the game processing is determined (step S101).

If the selected symbol combination is appropriate, whether or not it is a specific symbol combination (for example, a symbol combination defining a specific game element such as “7 7 7” shown in FIG. 4) is determined (step S102).

If the symbol combination is a specific symbol combination, game processing is performed based on the game element set for the symbol combination. For example, if the specific symbol combination defines a specific game element such as “7 7 7” shown in FIG. 4, game processing is performed conforming to the specific game element. For example, the player selects a division area (position) in the possession of the opponent. In the game processing, the selected division area (position) is changed to the division area (position) in the possession of the player. The game processing is by way of example and can be defined as desired in response to the game rule (step S103).

On the other hand, if the symbol combination is not a specific symbol combination, game processing is performed based on the game elements responsive to the symbol combination, and the division area (position) is selected and is placed in the possession of the player who corresponds to the game elements (step S104).

Whether or not additional variation of division area (position) is possible with respect to the division areas (positions) determined at step S103 or S104 is determined (step S105) for determining whether or not the game is substantially over (step S106).

If the game is not over (NO at step S106), the process returns to step S100 and steps from S100 to S106 are repeated according to the next player.

On the other hand, if the game is over (YES at step S106), the number of the division areas (positions) of each of the players are determined to determine which of the players wins the game (step S107), and the game score is displayed on the game display unit (liquid crystal panel 105d) (step S108).

According to the result of the bonus game (win or loss), or to the amount of areas obtained by the player, a predetermined amount of medals are paid out from the payout opening 119.

In the fourth embodiment, the gaming machine 100 is configured to let the player select the area (position) when the combination of the game element (symbols) arranged on the stopped reels corresponds to a specific game element such as “7 7 7” shown in FIG. 4. However, the gaming machine 100 may be configured that the selection of the area to be obtained by the player is automatically made by the main CPU 142.

As described above with reference to the embodiments, the gaming machine includes display unit for the player to select a symbol and display unit for displaying the game state, whereby it is made possible to apply the gaming machine to various games without being limited by display symbols and the gaming machine enables not only a single player, but also two or more players to enter a game and the application range of the gaming machine to games can be widened.

The player wins or loses a game according to more than one operation and game element combination obtained by each operation rather than a simple symbol combination determined by one operation, whereby the game can be provided with competition and strategy properties for improving interest.

The above described embodiments can be also applied in the mode of a gaming machine and the mode of a gaming program.

According to the embodiments, there is provided a gaming machine including symbol display unit for variably displaying a plurality of symbols; game element acquisition unit for selecting a symbol displayed on the symbol display unit and acquiring a game element based on the selected symbol; game processing unit for performing game processing for players to compete with each other for the number of acquired areas based on the game element acquired in the game element acquisition unit; and game display unit for displaying the processing result of the game processing unit.

The symbol display unit is a mechanism of a display for rotating a plurality of symbols provided on each reel, thereby varying and displaying the symbols, for example, and can display a combination of symbols by using a plurality of reels. The game element acquisition unit includes a selection function of selecting the symbols displayed on the symbol display unit and a game element acquisition function of acquiring a game element based on the selected symbols.

Here, the game element is an element that configures a game and an element for progressing a game. For example, the game element is an element that indicates at least one of a movement of a piece that belongs to each of the players and an order of the players to play the game. The game element is determined in accordance with the game rule.

The game element acquisition unit determines the game element based on the selected symbol combination and the game is formed and is advanced according to the game element, whereby the game can be provided with competition and strategy properties without determining the win or loss of the game only by one displayed symbol. The symbols selected in the game element acquisition unit are displayed on the symbol display unit.

The game processing unit performs game processing for players to compete with each other for the number of acquired areas based on the game element acquired in the game element acquisition unit, and displays the processing result on the game display unit. In the game processing for players to compete with each other for the number of acquired areas, the player wins the game by acquiring a greater number of division areas provided by dividing a predetermined area.

To perform the game processing, the game processing unit includes area partition unit for determining a division area and possession for a plurality of division areas making up a predetermined area and determining which division area is in possession of which player based on the game element acquired in the game element acquisition unit, thereby partitioning the predetermined area; area storage unit for storing the area partition state determined by the area partition unit; and area determination unit for determining the number of the division areas based on the area partition state stored in the area storage unit.

Therefore, the area partition unit determines the division area and determines the determined division area is in possession of which player based on the game element. The area partition unit changes player's possession of the division area based on the game element in accordance with the game rule. For example, in the area partition state, if the area of one player is sandwiched between the areas of an opponent player according to the game element, the player's possession of the sandwiched area is changed to the opponent player.

The symbol display unit may include at least one mechanical reel for rotating with a symbol row having a plurality of symbols provided on the outer periphery of the reel or at least one electric reel for producing electric circulating display of a plurality of symbols.

The game element acquisition unit controls starting and stopping of rotation of the mechanical reel of the symbol display unit or circulating display of the electric reel of the symbol display unit. For example, the game element acquisition unit controls the gaming machine so as to start rotation of the mechanical reel or circulating display of the electric reel as a start switch is operated and stop rotation of the mechanical reel or circulating display of the electric reel as a stop switch is operated. A symbol and a game element are acquired from the stop state of the reel under the control of the game element acquisition unit.

If the selected symbol is an inappropriate symbol, symbol re-selection processing or shift processing until an appropriate symbol is selected is performed.

If the selected symbol is an inappropriate symbol, the game element acquisition unit has a first processing mode in which it includes re-selection instruction unit. If the selected symbol is an inappropriate symbol, the re-selection instruction unit again starts and stops rotation of the mechanical reel or circulating display of the electric reel for again selecting a symbol.

The game element acquisition unit has a second processing mode in which it includes next-symbol selection unit. If the selected symbol is an inappropriate symbol, the next-symbol selection unit shifts the stop position of rotation of the mechanical reel or circulating display of the electric reel to an appropriate symbol.

The symbol display unit and the game display unit are formed on a common liquid crystal display surface as liquid crystal display; in addition, the symbol display unit can also be implemented as mechanical display and the game display unit can also be implemented as liquid crystal display.

In the display mode in which the symbol display unit is implemented as mechanical display and the game display unit is implemented as liquid crystal display, the game display unit can be formed on a transmission liquid crystal display surface, the symbol display unit of the mechanical reel can be placed on the back of the transmission liquid crystal display surface, and reel display of the mechanical reel can be produced through the transmission liquid crystal display surface.

To form a game in a battle mode, symbol display unit are provided in a one-to-one correspondence with players. The game element acquisition unit displays the acquired symbol on the symbol display unit provided for each player. According to the configuration, each player can select a symbol independently of other players and can know the selected symbol.

The game display unit is provided for each of the plurality of symbol display unit; in addition, one game display unit can also be provided for a plurality of symbol display unit. According to the configuration wherein the game display unit is provided for each of the plurality of symbol display unit, effect display matching the game state of each player can be produced. According to the mode, applying the gaming machine to a game mode played through a network is facilitated.

According to the configuration wherein one game display unit is provided for a plurality of symbol display unit, each player can select and display a symbol using the symbol display unit provided for the player and all players can observe one shared game display unit. Spectators other than the players can also watch a game on the shared game display unit.

According to the embodiments, there is provided a gaming program for causing a computer to execute the steps of displaying a varying state and a stop state of a plurality of symbols; varying a plurality of symbols and acquiring a game element from the symbol at the stop position; taking out a specific element from the acquired game element, determining one of division areas making up a predetermined area using the specific element, taking out a possession element from the acquired game element, determining possession of the determined division area, extracting a division area in the same possession existing in any of longitudinal, lateral, or slanting direction with a division area in different possession between relative to the division area in the determined possession, changing possession of the division area in the different possession sandwiched between the division areas, partitioning the predetermined area, and determining possession; and determining the number of division areas in the possession of one player and that in the possession of another player in the predetermined area.

The gaming program causes a computer to execute the steps, whereby a game element is acquired according to symbol selection, a predetermined area is partitioned based on the acquired game element, possession is determined, the number of division areas in the possession of one player and that in the possession of another player are determined, and game processing is performed.

According to the embodiments described above, the application range in the game types, the number of players entering a game, etc., can be widened in the gaming machine using a symbol combination. The gaming machine can be provided with competition properties for improving interest by more than one operation and game element combination obtained by each operation.

The gaming machine as described above with reference to the embodiments can be applied not only to a reversi-type game, but also to a game for players to complete with each other for the number of acquired limited areas.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable those skilled in the art to utilize the invention in various embodiments and with various modifications as are suited to the particular use contemplated. It is intended that the scope of the invention be defined by the claims appended hereto, and their equivalents.

1. A gaming machine comprising:
a symbol display unit that variably displays a plurality of symbols arranged on a reel;
a game element acquisition unit that selects a symbol displayed on the symbol display unit and acquires a game element based on the selected symbol;
a game processing unit that performs game processing for players to compete with each other for a number of acquired areas based on the game element acquired in the game element acquisition unit; and
a game display unit that displays the processing result of the game processing unit.

2. The gaming machine as claimed in claim 1, wherein the game processing unit includes:
an area partition unit that determines a division area and possession thereof for a plurality of division areas that constitutes a predetermined area based on the game element acquired in the game element acquisition unit, thereby determining possession of each of the division area that partitions the predetermined area as an area partition state;
an area storage unit that stores the area partition state determined by the area partition unit; and
an area determination unit that determines a number of the division areas based on the area partition state stored in the area storage unit.

3. The gaming machine as claimed in claim 2, wherein the area partition unit changes the possession of the division area based on the game element in accordance with a game rule.

4. The gaming machine as claimed in claim 1, wherein the symbol display unit includes at least one reel for rotating a symbol row having a plurality of symbols provided on an outer periphery of the reel, and
wherein the game element acquisition unit controls starting and stopping of rotation of the reel to acquire the symbol and the game element.

5. The gaming machine as claimed in claim 4, wherein the reel is provided as a mechanical reel.

6. The gaming machine as claimed in claim 4, wherein the reel is provided as a video reel.

7. The gaming machine as claimed in claim 4, further comprising a start switch and a stop switch,
wherein the game element acquisition unit controls the symbol display unit so as to start the rotation of the reel when the start switch is operated and to stop the rotation of the reel when the stop switch is operated.

8. The gaming machine as claimed in claim 4, further comprising a start switch,
wherein the game element acquisition unit controls the symbol display unit so as to start the rotation of the reel when the start switch is operated and to automatically stop the rotation.

9. The gaming machine as claimed in claim 4, wherein the game element acquisition unit further includes a re-selection instruction unit that repeats to start and stop the rotation of the reel for re-selecting the symbol when the selected symbol is inappropriate for proceeding the game.

10. The gaming machine as claimed in claim 4, wherein the game element acquisition unit further includes a next-symbol selection unit that shifts a stop position of the reel to an appropriate symbol when the selected symbol is inappropriate for proceeding the game.

11. The gaming machine as claimed in claim 1, further comprising a liquid crystal display,
wherein the symbol display unit and the game display unit displays the symbols and the processing result of the game processing unit on the liquid crystal display.

12. The gaming machine as claimed in claim 5, further comprising a liquid crystal display,
wherein the game display unit displays the processing result of the game processing unit on the liquid crystal display,
wherein the mechanical reel is provided behind the liquid crystal display, and
wherein the liquid crystal display is configured to allow displaying the mechanical reel therethrough.

13. The gaming machine as claimed in claim 1, further comprising a plurality of the symbol display units provided respectively for each of the players,
wherein the game element acquisition unit displays the symbol acquired for each of the players on the respective symbol display units.

14. The gaming machine as claimed in claim 13, further comprising a plurality of the game display unit provided respectively for each of the symbol display units.

15. The gaming machine as claimed in claim 13, wherein the game display unit is provided for more than one of the symbol display units.

16. The gaming machine as claimed in claim 1, wherein at least one computer character is included in the players,
wherein the game processing unit automatically performs the operation for the computer character.

17. The gaming machine as claimed in claim 1, wherein the game element is an element that configures the game and an element for progressing the game.

18. The gaming machine as claimed in claim 17, wherein the game element indicates at least one of a movement of a piece that belongs to each of the players and an order of the players to play the game.

19. The gaming machine as claimed in claim 1, wherein the game processing unit performs the game as a bonus game that starts when the symbols are stopped in a specific arrangement that is defined to award a win for the bonus game.

20. The gaming machine as claimed in claim 19, wherein the game processing unit performs the bonus game when a specific symbol combination of symbols is aligned on a pay line that defines the symbol combination.

21. The gaming machine as claimed in claim 1, wherein the game processing unit performs the game of a reversi-type game.

22. A computer-readable program product for causing a computer to execute:
displaying a varying state and a stop state of a plurality of symbols;
varying the symbols and acquiring a game element from the symbol at a stop position;
partitioning a predetermined area into a plurality of division areas and determining possession of each of the division areas;
determining one of the division areas based on a specific element extracted out from the acquired game element;
determining possession of the determined division area by extracting out a possession element from the acquired game element;
extracting a division area in the same possession existing in any of longitudinal, lateral, or slanting direction with a division area in different possession between relative to the division area in the determined possession;
changing possession of the division area in the different possession sandwiched between the division areas; and
determining the division areas possessed by each of a plurality of players and determines a number of the possessed division areas for each of the players.

23. An automatic game performing method executed in a computer comprising the steps of:
displaying a varying state and a stop state of a plurality of symbols;
varying the symbols and acquiring a game element from the symbol at a stop position;
partitioning a predetermined area into a plurality of division areas and determining possession of each of the division areas;
determining one of the division areas based on a specific element extracted out from the acquired game element;
determining possession of the determined division area by extracting out a possession element from the acquired game element;
extracting a division area in the same possession existing in any of longitudinal, lateral, or slanting direction with a division area in different possession between relative to the division area in the determined possession;
changing possession of the division area in the different possession sandwiched between the division areas; and
determining the division areas possessed by each of a plurality of players and determines a number of the possessed division areas for each of the players.
